(19) United States
(12) Patent Application Publication
(10) Pub. No.: US 2007/0025740 A1
(43) Pub. Date: Feb. 1, 2007

(54) Intermediate transfer belt, production method thereof, and image-forming device using the intermediate transfer belt

(75) Inventors: Seiichi Katoh, Kanagawa (JP); Hiroshi Miyamoto, Kanagawa (JP); Tsuyoshi Miyamoto, Kanagawa (JP); Shoichi Morita, Kanagawa (JP); Toshie Furuya, Kanagawa (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/397,857

(22) Filed: Apr. 5, 2006

(30) Foreign Application Priority Data
Jul. 26, 2005 (JP) 2005-216336
Dec. 26, 2005 (JP) 2005-373614

(51) Int. Cl. G03G 15/00

(52) U.S. Cl. 399/1

(57) ABSTRACT

The present invention provides an intermediate transfer belt comprising a polyimide resin comprising polyaniline, wherein the absolute maximum length of the largest particle of the polyaniline is approximately 10.0 μm or less, a preparation thereof, and an image-forming device comprising the intermediate transfer belt.

### CROSS-REFERENCE TO RELATED APPLICATION

This application claims priority under 35 USC 119 from Japanese Patent Application Nos. 2005-216336 and 2005-373614, the disclosures of which are incorporated by reference herein.

### BACKGROUND OF THE INVENTION

1. Field of the Invention

The present invention relates to an image-forming device using an electrophotographic process, such as electrophotographic copying machine, laser printer, facsimile, and multi-function OA devices thereof. In particular to an intermediate transfer belt for use in image-forming devices that form an image by primary-transferring a toner image formed on an image holding member onto an intermediate transfer body and then retransferring the image onto a recording medium such as paper, a method of producing the same, and an image-forming device equipped with the intermediate transfer belt.

2. Description of the Related Art

In image-forming devices using the electrophotographic processes, a visible toner image is formed by charging an image holding member being a photoreceptor of an inorganic or organic material uniformly, forming an electrostatic latent image thereon, for example, with a laser beam modulated according to an image signal, and developing the electrostatic latent image with charged toner. The toner image is then electrostatically transferred, via an intermediate transfer body or directly, onto an image-receiving medium such as recording paper, giving a desirable reproduced image. In particular, there are various known image-forming devices using a process of primary-transferring a toner image formed on the image holding member onto an intermediate transfer body and additionally secondary-transferring the toner image on the intermediate transfer body onto recording paper.

In the image-forming devices using such an intermediate-transfer process, for example, a semiconductive endless belt is used favorably as the intermediate transfer body.

Specifically, for example, endless belts having at least a polyimide layer containing polyimide as the principal constituent as well as polyaniline, and a dopant for making the polyaniline electrically conductive are known (for example, Japanese Patent Application Laid-Open (JP-A) No. 2001-109277).

A seamless semiconductive belt which is resin belt having a multi-layer structure of at least two layers including a layer of polyimide and polyaniline and a layer of polyimide is also known (JP-A No. 2004-157474).

In addition, a semiconductive resin sheet applicable to the semiconductive endless belt that is made of a polymer blend of polyimide and polyaniline in the undoped state is known (for example, JP-A No. 2003-226765).

The polyimide-containing layers (sheets) described in JP-A Nos. 2004-157474 and 2003-226765 above are prepared by dissolving an insulative undoped polyaniline in a solvent containing dissolved polyamic acid (for example, NMP or DMAc) and thus preparing a coating solution containing a mixture of polyaniline in the undoped state and polyamic acid, applying the coating solution in a desired shape, and baking the coated film. Since undoped polyaniline is not highly soluble in the NMP or DMAc solvent, it often gelates therein, and easily generates gel when mixed with polyamic acid due to the influence of the acid, shortening the pot life of the solution (film forming solution) drastically. In addition, the gel generated, which is soft in the solution, is not easily removed by filtration, and thus, the belt or sheet after casting often contains microgels of about 1.0 μm and larger gels of about several to 50 μm (occasionally, larger gels when the polyaniline is not dissolved sufficiently). Further, the gels in the belt or sheet obtained after baking are harder, causing problems such as raised spots and irregularity on the surface of the belt or sheet and deterioration of the surface smoothness thereof.

As a result, when applied to an intermediate transfer belt, the semiconductive belt or sheet thus obtained has problems such as inferior surface smoothness and fluctuation of resistivity in microregions caused by bulky polyaniline particles (bulky gels) present therein, consequently leading to problems in the quality of transferred image such as white deletion.

### SUMMARY OF THE INVENTION

The present invention has been made in view of the above circumstances and provides an intermediate transfer belt, a production method thereof, and an image-forming device using the intermediate transfer belt.

According to an aspect of the present invention, an intermediate transfer belt comprises a polyimide resin comprising a polyaniline, wherein the absolute maximum length of the largest particle of the polyaniline is approximately 10.0 μm or less.

According to another aspect of the present invention, an image-forming device comprises an image holding member whereon an electrostatic latent image corresponding to image information is formed, a developing device making visible the electrostatic latent image formed on the image holding member as a toner image with a toner, an intermediate transfer belt whereon the toner image formed on the image holding member is primary-transferred, and a bias mechanism which secondary-transfers the unfixed toner image on the intermediate transfer belt onto a recording medium, wherein

the intermediate transfer belt is the intermediate transfer belt comprising a polyimide resin comprising polyaniline, wherein the absolute maximum length of the largest particle of the polyaniline is approximately 10.0 μm or less.

According to another aspect of the present invention, a method of producing an intermediate transfer belt comprising:

pulverizing a polyaniline in an undoped state into particles having a 50 percentile particle diameter (volume basis) in the range of approximately 0.05 to 3.0 μm and a 90 percentile particle diameter (volume basis) in the range of one to two times the 50 percentile particle diameter (volume basis);

adding a dopant for making the polyaniline conductive thereto;

blending the mixture with a polyamic acid; and

drying and sintering the mixture.

According to another aspect of the present invention, a method of producing an intermediate transfer belt comprising:

pulverizing a self-doping polyaniline into particles having a 50 percentile particle diameter (volume basis) in the range of approximately 0.05 to 3.0 μm and a 90 percentile particle diameter (volume basis) in the range of one to two times the 50 percentile particle diameter (volume basis);

mixing the particles with a polyamic acid; and

drying and sintering the mixture.

### BRIEF DESCRIPTION OF THE DRAWINGS

Preferred embodiments of the present invention will be described in detail based on the following figures, wherein:

FIG. 1 is a schematic view illustrating a high speed image-forming device outputting many sheets of paper;

FIG. 2 is a schematic view illustrating a medium-to-low-speed image-forming device outputting a fewer sheets of paper; and

FIG. 3 is a drawing showing a method of determining the definition of image.

### DETAILED DESCRIPTION OF THE INVENTION

Hereinafter, the intermediate transfer belt, the production method thereof, and the image-forming device according to the present invention will be described in detail.

<Intermediate Transfer Belt>

The intermediate transfer belt according to the invention is an intermediate transfer belt comprising a polyimide resin comprising polyaniline, wherein the absolute maximum length of the largest particle of the polyaniline is 10.0 μm or less.

Hereinafter in the present specification, the particle of polyaniline will be referred to as “polyaniline particle” and the maximum polyaniline particle as “largest polyaniline particle”.

In the invention, the “absolute maximum length of the largest particle of the polyaniline (largest polyaniline particle)” is the distance between two most separated points in the largest polyaniline particle that has the longest particle length among the particles of polyaniline (polyaniline particles) contained in the polyimide resin.

Thus, the largest polyaniline particle means the longest particle among the polyaniline particles (including gels, aggregates, and others) observable in the intermediate transfer belt (polyimide resin).

In the invention, the absolute maximum length of the largest polyaniline particle is 10.0 μm or less, preferably 8.0 μm or less, and more preferably 7.0 μm or less.

In the invention, the absolute maximum length of the largest polyaniline particle is determined by staining the cross section of a sample cut off from an intermediate transfer belt by electron-beam irradiation, incorporating optical images of the polyaniline particles therein under a transmission electron microscope (hereinafter, referred to as TEM), making the image processing, and measuring the maximum length between two outer edges in the largest polyaniline particle.

The method of determining the absolute maximum length of the largest polyaniline particle used in the invention will be described below in detail.

First, a rectangular sample of 1 mm×8 mm in size is cut off from an intermediate transfer belt (the short side represents the side to be observed or the machine direction during molding). A metal is deposited on one face of the sample, for differentiation of the top and bottom surfaces of sample, and the sample is then embedded in an epoxy resin. After hardening, a thin section having a thickness of approximately 0.1 μm is prepared by using a microtome with a diamond knife. The microtome used is, for example, UltraCut N manufactured by Reichert. If there is no polyaniline observed in the section obtained, the polyaniline is visualized by electron beam staining. The stain is selected, for example, from osmium tetroxide, ruthenium tetroxide, phosphotungstic acid, and iodine, properly considering the staining condition and the like.

Six images (three in the thickness direction×two in width direction=6) per section are obtained under a transmission electron microscope (TEM: Tecnai G2 manufactured by FEI) under the condition of an accelerating voltage of 100 KV and a magnification of 12,000 times.

Then, the particles in each of the TEM images at a magnification of 12,000 thus obtained are analyzed by using an image analyzer Image Pro Plus manufactured by U.S. Media Cybernetics. The TEM image is adjusted to the brightness and contrast suitable for measurement, and the shading thereof is corrected if there is some color graduation in the image. If there are filler particles and others in addition to the polyaniline particles contained in the sample, they are removed previously by making the image processing while modifying the density of the particles. Some polyaniline particles relatively larger in each visual field are chosen, and the maximum length between two outer edges of each of the polyaniline particles is determined. The measurement of image is repeated in six visual fields, and the maximum length among those in the images in six visual fields is designated as the absolute maximum length of the largest polyaniline particle in the sample (polyaniline particles overlapping or in contact with each other in the image are regarded as one polyaniline particle, and the absolute maximum length thereof is measured).

The sections for measurement are prepared from the rectangular samples cut off from an intermediate transfer belt at a total of nine points, 3 points in the width direction×3 points in the length direction. The measurement is repeated for the samples from the nine points, and the maximum value observed is designated as the absolute maximum length of the largest polyaniline particle in the intermediate transfer belt.

The intermediate transfer belt according to the invention, which is made of a polyimide resin, is superior in mechanical properties and heat resistance. In addition to these properties, addition of the polyaniline particles for improvement in conductivity, of which the absolute maximum length of the longest particle, i.e., the largest polyaniline particle, is 10.0 μm or less, is effective in reducing the number of raised spots or the irregularity of the surface of intermediate transfer belt and improving the smoothness thereof and preventing fluctuation in resistivity in the microregions because of the absence of bulky polyaniline particles.

As a result, the image-forming device equipped with the intermediate transfer belt according to the invention improves the quality of transferred image.

The polyaniline particles in the intermediate transfer belt according to the invention preferably have a 50 percentile particle diameter (number basis) in the range of 0.05 to 3.0 μm and a 90 percentile particle diameter (number basis) in the range of one to two times the 50 percentile particle diameter (number basis).

A particle diameter and a particle size distribution of polyaniline particles in the range above lead to advantageous effects of reducing the number of raised spots and the irregularity of the intermediate transfer belt and improving the surface smoothness thereof and giving an output image higher in definition and lower in graininess.

The 50 percentile particle diameter (number basis) is more preferably in the range of 0.05 to 2.00 μm and the 90 percentile particle diameter (number basis) in the range of one to two times the 50 percentile particle diameter (number basis).

The methods of determining the 50 percentile particle diameter of polyaniline particles and the particle size distribution by comparison between the 50 percentile particle diameter and the 90 percentile particle diameter will be described below.

The method of determining the particle size distribution (number basis) by comparison between the 50 percentile particle diameter (number basis) and the 90 percentile particle diameter (number basis) of the polyaniline particles in the intermediate transfer belt according to the invention (cross section in the thickness direction) will be described first. By using a section prepared similarly to the measurement of the absolute maximum length of the largest polyaniline particle described above, TEM images in six visual fields at three points in the thickness direction (top surface, central, and bottom (opposite) surface regions)×two points in the width direction are obtained under the condition of an accelerating voltage of 100 KV and a magnification of 35,000 times.

Then, the polyimide resin and polyaniline particles shown in the TEM image obtained at a magnification of 35,000 times are analyzed by using an image analyzer Image Pro Plus manufactured by U.S. Media Cybernetics. The TEM image is adjusted to the brightness and contrast suitable for measurement, and the shading thereof is corrected if there is some color graduation in the image. If there are filler particles and others in addition to the polyaniline particles contained in the sample, they are removed previously by making the image processing while modifying the density of the particles. The particle diameter (as elliptical major axis) of each polyaniline particle in the image in each visual field is determined. The measurement is repeated for the images in six visual fields minute, and the particle size distribution (number basis) is determined from the average. The particle diameter is then determined, while the polyaniline particles only partially observable at the edge of image are removed, multiple polyaniline particles fused to each other are separated, and polyaniline particles apparently divided in the image are combined as needed.

The sections used in measurement are obtained from an intermediate transfer belt at nine points: three points in the width direction×three points in the length direction. The measurement is repeated for the nine sections, and the average is designated as the particle size distribution (number basis) of the polyaniline particles in intermediate transfer belt.

In an embodiment, the polyimide resin in the intermediate transfer belt according to the invention contains a dopant for making the polyaniline conductive additionally.

Alternatively in another embodiment, the polyaniline in the intermediate transfer belt according to the invention is a self-doping polyaniline. The self-doping polyaniline is a polyaniline having a group serving as dopant in the molecule and showing a self-doping action. If such a self-doping polyaniline is used, the intermediate transfer belt according to the invention may not contain any dopant additionally.

The intermediate transfer belt according to the invention can be prepared in the following two production processes (production methods of the intermediate transfer belt according to the invention).

[Preparation of Intermediate Transfer Belt (1)]

The first method of producing the intermediate transfer belt according to the invention includes pulverizing an undoped polyaniline into particles having a 50 percentile particle diameter (volume basis) in the range of 0.05 to 3.0 μm and a 90 percentile particle diameter (volume basis) in the range of one or more and two or less times larger than the 50 percentile particle diameter (volume basis), adding thereto a dopant for making the polyaniline conductive, blending the mixture with an added polyamic acid, and drying and sintering the mixture.

The “undoped polyaniline (Emeraldine Base)” corresponds to the structure “B” shown below, one of the four possible structures of polyaniline. Specific examples thereof include the polyanilines prepared by the method described in JP-A No. 8-259709, paragraph Nos. [0042] to [0044]; those prepared according to the method for solvent-separation polyanilines described in Research Report of Industrial Technology Center of Aichi Prefecture No. 37, and the like. In addition, commercially available products thereof include “Panipol PA” manufactured by Panipol.

The number-average molecular weight of the undoped polyaniline is preferably 4,000 to 400,000, for preservation of mechanical strength and addition of conductivity.

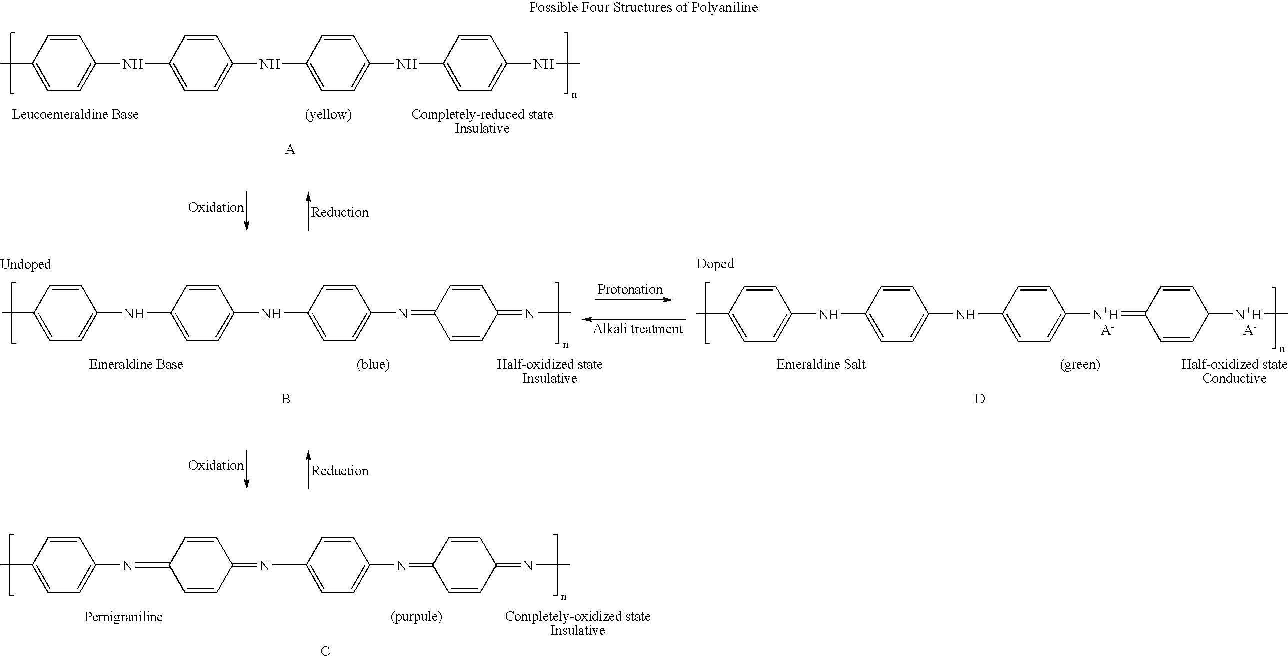

Physical means such as pulverizer may be used for pulverization of the polyaniline in the undoped state, and both wet and dry pulverization methods are applicable.

Examples of the pulverizers for use include wet jet mill, dry jet mill, and the like. Generally, when the undoped polyaniline is granular or powdery in shape, pulverization in dry jet mill is better in processability than in wet jet mill, as it eliminates the need for substitution of the solvent after pulverization.

Such mechanical pulverization may be repeated several times. For example, when the pulverization is performed twice in a wet jet mill, if the temperature of dispersion rises after the first pulverization, it is preferable to carry out the next pulverization after cooling. The cooling then is preferably carried out in a low-temperature and low-humidity environment at approximately 10° C. and 15% RH, for prevention of contamination of undesirable water.

When a wet method is used for pulverization of the undoped polyaniline, examples of the liquids for use in dispersion of the polyaniline include ethanol, toluene, xylene, and the like.

The content of the undoped polyaniline in the dispersion is preferably in the range of 3 to 20 mass %, from the viewpoints of easiness of pulverization and control of particle size distribution.

The polyaniline is pulverized until it satisfies the following conditions on particle size distribution:

A 50 percentile particle diameter (volume basis) in the range of 0.05 to 3.0 μm and a 90 percentile particle diameter (volume basis) in the range of one or more and two or less times larger than the 50 percentile particle diameter (volume basis); and more preferably, a 50 percentile particle diameter (volume basis) of 0.05 to 2.0 μm in the range and a 90 percentile particle diameter (volume basis) in the range of one to two times the 50 percentile particle diameter (volume basis).

In addition, the 100 percentile particle diameter (volume basis) is preferably approximately five times or less the 50 percentile particle diameter (volume basis), for prevention of contamination with abnormally bulky particles.

The absolute maximum length of the largest polyaniline particle contained in the intermediate transfer belt can be reduced to 10.0 μm or less by pulverization of the particles to the particle diameter in the range above.

In the invention, these particle size distributions are determined by using a laser diffraction/scattering particle-size-distribution analyzer (LA-700: manufactured by Horiba).

After completion of the polyaniline pulverization step, a dopant for making the polyaniline conductive is added to the dispersion.

The dopant for use is preferably, normally a protonic acid. Protonic acids favorable as the dopant are those having an acid dissociation constant pKa of 4.8 or less. Examples of the protonic acids include inorganic acids such as hydrochloric acid, sulfuric acid, nitric acid, phosphoric acid, fluoroboric acid, phosphofluoric acid, and perchloric acid, and organic acids having an acid dissociation constant pKa of 4.8 or less.

The organic acid is, for example, an organic carboxylic acid or a phenol preferably having an acid dissociation constant pKa of 4.8 or less. Examples of the organic acids include mono- or poly-basic aliphatic, aromatic, araliphatic, and alicyclic acids. Such an organic acid may have a hydroxyl group, a halogen atom, a nitro group, a cyano group, an amino group, or the like; and typical examples of the organic acids include acetic acid, n-butyric acid, pentadecafluorooctanoic acid, pentafluoroacetic acid, trifluoroacetic acid, trichloroacetic acid, dichloroacetic acid, monofluoroacetic acid, monobromoacetic acid, monochloroacetic acid, cyanoacetic acid, acetylacetic acid, nitroacetic acid, triphenylacetic acid, formic acid, oxalic acid, benzoic acid, m-bromobenzoic acid, p-chlorobenzoic acid, m-chlorobenzoic acid, p-chlorobenzoic acid, o-nitrobenzoic acid, 2,4-dinitrobenzoic acid, 3,5-dinitrobenzoic acid, picric acid, o-chlorobenzoic acid, p-nitrobenzoic acid, m-nitrobenzoic acid, trimethylbenzoic acid, p-cyanobenzoic acid, m-cyanobenzoic acid, thymol blue, salicylic acid, 5-aminosalicyclic acid, o-methoxybenzoic acid, 1,6-dinitro-4-chlorophenol, 2,6-dinitrophenol, 2,4-dinitrophenol, p-oxybenzoic acid, bromophenol blue, mandelic acid, phthalic acid, isophthalic acid, maleic acid, fumaric acid, malonic acid, tartaric acid, citric acid, lactic acid, succinic acid, α-alanine, β-alanine, glycine, glycollic acid, thioglycollic acid, ethylenediamine-N,N′-diacetic acid, ethylenediamine-N,N,N′,N′-tetraacetic acid, and the like.

Alternatively, the organic acid may contain a sulfonic or sulfuric acid group. Examples of such organic acids include aminonaphtholsulfonic acid, metanilic acid, sulfanilic acid, allylsulfonic acid, laurylsulfuric acid, xylenesulfonic acid, chlorobenzenesulfonic acid, methanesulfonic acid, ethanesulfonic acid, 1-propanesulfonic acid, 1-butanesulfonic acid, 1-hexanesulfonic acid, 1-heptanesulfonic acid, 1-octanesulfonic acid, 1-nonanesulfonic acid, 1-decanesulfonic acid, 1-dodecanesulfonic acid, benzenesulfonic acid, styrenesulfonic acid, p-toluenesulfonic acid, naphthalenesulfonic acid, ethylbenzenesulfonic acid, propylbenzenesulfonic acid, butylbenzenesulfonic acid, pentylbenzenesulfonic acid, hexylbenzenesulfonic acid, heptylbenzenesulfonic acid, octylbenzenesulfonic acid, nonylbenzenesulfonic acid, decylbenzenesulfonic acid, undecylbenzenesulfonic acid, dodecylbenzenesulfonic acid, pentadecylbenzenesulfonic acid, octadecylbenzenesulfonic acid, diethylbenzenesulfonic acid, dipropylbenzenesulfonic acid, dibutylbenzenesulfonic acid, methylnaphthalenesulfonic acid, ethylnaphthalenesulfonic acid, propylnaphthalenesulfonic acid, butylnaphthalenesulfonic acid, pentylnaphthalenesulfonic acid, hexylnaphthalenesulfonic acid, heptylnaphthalenesulfonic acid, octylnaphthalenesulfonic acid, nonylnaphthalenesulfonic acid, decylnaphthalenesulfonic acid, undecylnaphthalenesulfonic acid, dodecylnaphthalenesulfonic acid, pentadecylnaphthalenesulfonic acid, octadecylnaphthalenesulfonic acid, dimethylnaphthalenesulfonic acid, diethylnaphthalenesulfonic acid, dipropylnaphthalenesulfonic acid, dibutylnaphthalenesulfonic acid, dipentylnaphthalenesulfonic acid, dihexylnaphthalenesulfonic acid, diheptylnaphthalenesulfonic acid, dioctylnaphthalenesulfonic acid, dinonylnaphthalenesulfonic acid, trimethylnaphthalenesulfonic acid, triethylnaphthalenesulfonic acid, tripropylnaphthalenesulfonic acid, tributylnaphthalenesulfonic acid, camphorsulfonic acid, acrylamido-t-butylsulfonic acid, para-phenolsulfonic acid, and the like.

Alternatively, a multifunctional organic sulfonic acid having two or more sulfonic acid groups in the molecule may also be used in the invention. Examples of the multifunctional organic sulfonic acids include ethanedisulfonic acid, propanedisulfonic acid, butanedisulfonic acid, pentanedisulfonic acid, hexanedisulfonic acid, heptanedisulfonic acid, octanedisulfonic acid, nonanedisulfonic acid, decanedisulfonic acid, benzenedisulfonic acid, naphthalenedisulfonic acid, toluenedisulfonic acid, ethylbenzenedisulfonic acid, propylbenzenedisulfonic acid, butylbenzenedisulfonic acid, dimethylbenzenedisulfonic acid, diethylbenzenedisulfonic acid, dipropylbenzenedisulfonic acid, dibutylbenzenedisulfonic acid, methylnaphthalenedisulfonic acid, ethylnaphthalenedisulfonic acid, propylnaphthalenedisulfonic acid, butylnaphthalenedisulfonic acid, pentylnaphthalenedisulfonic acid, hexylnaphthalenedisulfonic acid, heptylnaphthalenedisulfonic acid, octylnaphthalenedisulfonic acid, nonylnaphthalenedisulfonic acid, dimethylnaphthalenedisulfonic acid, diethylnaphthalenedisulfonic acid, dipropylnaphthalenedisulfonic acid, dibutylnaphthalenedisulfonic acid, naphthalenetrisulfonic acid, naphthalenetetrasulfonic acid, anthracenedisulfonic acid, anthraquinonedisulfonic acid, phenanthrenedisulfonic acid, fluorenonedisulfonic acid, carbazoledisulfonic acid, diphenylmethanedisulfonic acid, biphenyldisulfonic acid, terphenyldisulfonic acid, terphenyltrisulfonic acid, naphthalenesulfonic acid-formalin condensates, phenanthrenesulfonic acid-formalin condensates, anthracenesulfonic acid-formalin condensates, fluorenesulfonic acid-formalin condensates, carbazolesulfonic acid-formalin condensates, and the like. The position of the sulfonic acid group in the aromatic rings is arbitrary.

Alternatively, the organic acid may be a polymer acid. Examples of the polymer acids include polyvinylsulfonic acid, polyvinylsulfuric acid, polystyrenesulfonic acid, sulfonated styrene-butadiene copolymers, polyallylsulfonic acid, polymethacrylsulfonic acid, poly-2-acrylamide-2-methylpropanesulfonic acid, poly-haloganated acrylic acids, polyisoprenesulfonic acid, N-sulfoaklylated polyanilines, ring-substituted polyanilines, and the like. A fluorine-containing polymer, known as Nafion (registered trade name of U.S. E.I. du Pont de Nemours and Company), is also used favorably as the polymer acid.

In addition, an ester from an organic acid and a polyhydroxy compound that has an acid terminal is also favorable as the organic acid in the invention. Examples of such polyhydroxy compounds include polyvalent alcohols such as ethylene glycol, propylene glycol, 1,3-propanediol, 1,4-butanediol, 1,3-butanediol, 1,5-pentanediol, neopentylglycol, 1,6-hexanediol, 1,4-bis(hydroxyethyl)cyclohexane, bisphenol A, hydrogenated bisphenol A, hydroxypivalyl hydroxypivalate, trimethylolethane, trimethylolpropane, 2,2,4-trimethyl-1,3-pentanediol, glycerol, hexanetriol, tris(2-hydroxyethyl)isocyanurate, and pentaerythritol; polyether glycols such as polyoxyethylene glycol, polyoxypropylene glycol, polyoxyethylene tetramethylene glycol, polyoxypropylene tetramethylene glycol, and polyoxyethylene polyoxypropylene polyoxytetramethylene glycol; modified polyether polyols prepared by ring-opening polymerization of ethylene oxide, propylene oxide, tetrahydrofuran, ethylglycidylether, propylglycidylether, butylglycidylether, phenylglycidylether, allylglycidylether, or the like with a polyvalent alcohol; and the like.

Such a dopant makes the undoped polyaniline having the structure “B”, one of the four possible structures of the polyaniline, conductive by protonation. Specifically, protonation of an imine nitrogen atom in quinonediimine in the structure “B” changes the molecule into the structure “D”, making the undoped polyaniline conductive.

Thus, the amount of the dopant used (addition amount) is determined properly according to the amount of quinonediimine structural units in the structure of the polyaniline in the undoped state.

The dopant is preferably added as a solution as it is dissolved at a particular concentration.

As described above, after addition of a dopant, the dispersion is mixed additionally with a polyamic acid solution, giving a coating solution.

Favorable mixing parts in preparation of the coating solution include stirrer, sand-grind mill, attriter, and the like, but are not particularly limited, if the parts can mix the coating solution to homogeneity.

The polyamic acid used can be prepared as a solution, by dissolving an almost equimolar mixture of a tetracarboxylic dianhydride or the derivative thereof and a diamine in a polar organic solvent and allowing them to react with each other in the liquid state. An aromatic tetracarboxylic dianhydride is preferable as the tetracarboxylic dianhydride, and an aromatic diamine as the diamine; but other compounds may be used as needed.

Examples of the aromatic tetracarboxylic dianhydrides include pyromellitic dianhydride (PMDA), 3,3′,4,4′-benzophenonetetracarboxylic dianhydride, 3,3′,4,4′-biphenyltetracarboxylic dianhydride (BPDA), 2,3,3′,4′-biphenyltetracarboxylic dianhydride, 2,3,6,7-naphthalenetetracarboxylic dianhydride, 1,2,5,6-naphthalenetetracarboxylic dianhydride, 1,4,5,8-naphthalenetetracarboxylic dianhydride, 2,2′-bis(3,4-dicarboxyphenyl)propane dianhydride, bis(3,4-dicarboxyphenyl)sulfone dianhydride, and the like. These anhydrides may be used alone or in combination of two or more.

Examples of the aromatic diamines include 4,4′-diaminodiphenylether (ODA), 4,4′-diaminodiphenylmethane, 3,3′-diaminodiphenylmethane, p-phenylenediamine, m-phenylenediamine, benzidine, 3,3′-dimethoxybenzidine, 4,4′-diaminodiphenylsulfone, 4,4′-diaminodiphenylsulfide, 4,4′-diaminodiphenylpropane, 2,2-bis[4-(4-aminophenoxy)phenyl]propane, and the like. These diamines may also be used alone or in combination of two or more.

In the invention, favorable combinations of the tetracarboxylic dianhydride and the aromatic diamine are 3,3′,4,4′-biphenyltetracarboxylic dianhydride and 4,4′-diaminodiphenylether, 3,3′,4,4′-biphenyltetracarboxylic dianhydride and 4,4′-diaminodiphenylether, and pyromellitic dianhydride and 4,4′-diaminodiphenylether, considering the moisture content, thermal expansion and surface microhardness of the resulting polyimide resin.

Examples of the solvents for use in the dopant and polyamic acid solutions described above include DMAc (dimethylacetamide), NMP (N-methyl-2-pyrrolidone), and the like.

A filler is preferably added to the coating solution for improvement in the elastic modulus of the intermediate transfer belt and reduction of the humidity and thermal expansion of the intermediate transfer belt.

Examples of the fillers include insulative fillers such as silica, alumina, mica, talc, whisker, and barium sulfate; conductive and semi-conductive fillers such as tin oxide, antimony-doped tin oxide, indium-doped tin oxide, antimony-doped titanium oxide, and carbon black; and the like. When a conductive or semi-conductive filler is used, it is possible to use it similarly to insulative fillers, by reducing its addition amount to its percolation threshold value or less.

In such a case, the 50 percentile particle diameter (volume basis) of the filler is preferably 0.1 μm or more. A particle diameter of 0.1 μm or more leads to a favorable reinforcement effect and favorable resistance to expansion.

As will be described below, the absolute maximum length of the largest filler particle in polyimide resin of the intermediate transfer belt according to the invention is preferably smaller than the absolute maximum length of the largest polyaniline particle, and thus, use of a filler having a diameter satisfying the relationship is preferable.

In addition, the loading rate is preferably 0.1 to 10% by volume fraction. A volume fraction of less than 0.1% may lead to insufficient reinforcement action, while a volume fraction of more than 10% to deterioration in the strength and consequently the toughness of the molded product, and thus, both are unfavorable.

Examples of the methods of dispersing the filler and breaking the aggregates thereof include, but are not limited to, physical means such as mixer, agitation with stirrer, parallel roll, and ultrasonic dispersion; and chemical methods, for example, of using a dispersant.

An endless belt-shaped intermediate transfer belt is prepared by using the coating solution obtained, for example, by the method (A) or (B) below. The intermediate transfer belt according to the invention may be prepared by any other method, if it allows preparation of a molding in the endless-belt shape.

Method (A):

A long film-shaped conductive polyimide film is prepared by applying a coating solution on a stainless steel endless belt with a T die continuously, drying the film in an oven, for example, at 170 to 190° C. for 30 minutes continuously, winding the resulting film, baking the film in a baking oven (tenter oven), for example, at 370 to 390° C. for 7 minutes continuously while allowing imide-conversion reaction to proceed, and winding the baked film. After cut into a suitable size, the polyimide film obtained is converted into a desirable endless belt, for example, according to the puzzle-cut seaming method described in JP-A No. 2000-145895.

Method (B):

An endless belt is prepared by applying a coating solution on the internal or external surface of a cylindrical metal mold and drying and sintering the film.

A cylindrical mold made of any one of various known raw materials such as resin, glass, and ceramic may be used instead of the cylindrical metal mold. Alternatively, a glass or ceramic layer may be formed on the surface of the metal or other mold, and a silicone- or fluorine-based mold-release agent may be used as needed.

It is also advantageous to use a method of controlling the thickness of the solution coated on the cylindrical metal mold, by using a film thickness-controlling mold having a properly adjusted clearance to the cylindrical metal mold, and removing excess solution while rotating the thickness-controlling mold in parallel with the cylindrical metal mold. If the thickness of the coating solution is properly adjusted in the step of applying the coating solution onto the cylindrical metal mold, there is no need for installing such a film thickness-controlling mold.

Then, the cylindrical metal mold carrying the coating solution is dried in a heated or vacuum environment until 30 mass % or more, preferably 50 mass % or more, of the solvent contained in the coating solution is evaporated (drying treatment).

The cylindrical metal mold is then heated at 200° C. to 450° C., allowing progress of the imide conversion reaction (baking treatment).

Then, removal of the imidated resin from the metal mold gives a desired endless belt. The endless belt may be further processed in a step of cutting both ends of the belt.

The endless belt is baked both in the methods (A) and (B) for acceleration of the imide conversion reaction. The imide-conversion temperature may vary according to the kind of the raw polyamic acid materials used, tetracarboxylic dianhydride and diamine, but is preferably a temperature at which the imide conversion is completed, for improvement in mechanical properties and electrical characteristics. The temperature may also vary according to the heat capacity of the metal mold, but baking at 200 to 450° C. for 5 to 45 minute is generally preferable.

[Preparation of Intermediate Transfer Belt (2)]

The second method of preparing the intermediate transfer belt according to the invention is a method, comprising pulverizing a self-doping polyaniline into a powder having a 50 percentile particle diameter (volume basis) in the range of 0.05 to 3.0 μm and a 90 percentile particle diameter (volume basis) in the range of one to two times the 50 percentile particle diameter (volume basis), and mixing it with an added polyamic acid, and drying and sintering the mixture.

The “self-doping polyaniline” is a polyaniline having a dopant acidic group (for example, sulfonic acid group) in the polyaniline structure. Specifically, for example, a self-doping polyaniline, polyaniline sulfonic acid having an average molecular weight of approximately 10,000, can be prepared by a known method [for example, J. Am. Chem. Soc., 113, 2665-2666 (1991), or others]. An example of the commercially available products thereof is a conductive coating agent aquaPASS-01 (aqueous solution of polyaniline sulfonic acid) manufactured by Mitsubishi Rayon Co., Ltd.

The number-average molecular weight of the self-doping polyaniline is preferably 4,000 to 400,000 for securing mechanical strength and providing conductivity.

A pulverization method similar to that for the undoped polyaniline in preparation of the intermediate transfer belt (1) may be used for pulverization of the self-doping polyaniline. Generally, if a granular self-doping polyaniline is available, use of a dry jet mill is easier in handling than use of a wet jet mill.

Examples of the liquids favorably used in dispersion of a self-doping polyaniline when a wet process is used for pulverization, include DMAc (dimethylacetamide), NMP (N-methyl-2-pyrrolidone), and the like.

The content of the self-doping polyaniline in the dispersion is preferably in the range of 3 to 20 mass % from the viewpoint of easiness in pulverization.

The particle size distribution of the self-doping polyaniline pulverized by the method is the same as that when an undoped polyaniline is pulverized as described above.

The self-doping polyaniline pulverized into the condition of the particle size distribution above is then mixed with a polyamic acid, giving a coating solution.

The mixing parts during preparation of the coating solution may be a stirrer, sand-grind mill, attriter, or the like, but is not particularly limited, if it can mix the coating solution to homogeneity.

The polyamic acid used then is the same as that described above in the method of preparing intermediate transfer belt (1).

Then, an endless belt-shaped intermediate transfer belt is prepared by using the coating solution obtained and by the method (A) or (B) described in the preparation of intermediate transfer belt (1).

The intermediate transfer belt according to the invention is prepared by the method described in the preparation of intermediate transfer belt (1) or (2) above.

The production method thereof is not limited to the methods (1) and (2), if it gives an intermediate transfer belt wherein the absolute maximum length of the largest polyaniline particle in the polyimide resin thereof is 10.0 μm or less. For example, an endless belt may be prepared by dissolving a solvent-soluble polyimide in a solvent such as NMP or DMAc, preparing a coating solution by adding a pulverized polyaniline thereto as described above, and applying the coating solution. Alternatively, an endless belt may be prepared by blending a pulverized polyaniline prepared as described above in a thermoplastic polyimide and extrusion-molding the resin by using a T die or a cyclic die.

When the polyimide resin in the intermediate transfer belt according to the invention thus obtained contains a filler, the absolute maximum length of the largest polyaniline particle (a) and the absolute maximum length of the largest filler particle (b) preferably satisfies the relationship represented by the following Formula (1):
10.0 μm≧Absolute maximum length (a)>Absolute maximum length (b)≧0.1 μm (1)

The “absolute maximum length of the largest filler particle” in the invention is the distance between two most separated points in the maximum filler particle that has the longest particle length among the filler particles contained in the polyimide resin.

Presence of a filler in polyimide resin is effective in preventing hygroscopic expansion by humidity and expansion by temperature, and presence of a filler satisfying the condition of Formula (1) above is effective in preventing the raised spots and irregularity and improving the surface smoothness of the transfer belt and preserving the graininess of the image outputted thereon without deterioration of its definition.

As a result, an image-forming device equipped with such an intermediate transfer belt gives high-quality transferred images.

The absolute maximum length of the filler can be determined by a method similar to that used in determination of the absolute maximum length of the largest polyaniline particle described above and by using the same test sample. The filler, which is different in color tone from polyimide or polyaniline, can be identified then, easily.

In a favorable embodiment, the polyimide resin for the intermediate transfer belt according to the invention contains a copolymer (having the following structure) of BPDA (3,3′,4,4′-biphenyltetracarboxylic dianhydride) and ODA (4,4′-diaminodiphenylether) or a mixture of a copolymer of BPDA (3,3′,4,4′-biphenyltetracarboxylic dianhydride) and ODA (4,4′-diaminodiphenylether) and a copolymer (having the following structure) of PMDA (pyromellitic dianhydride) and ODA (4,4′-diaminodiphenylether).

Such a copolymer is advantageous in that it is easier to prepare the coating solution during production of an intermediate transfer belt and also in that it is possible to adjust the surface micro-hardness into a favorable range.

By adding the filler described above additionally to such a polyimide resin, it is possible to improve the mechanical strength of the intermediate transfer belt and prevent the expansion of the intermediate transfer belt by humidity and temperature.

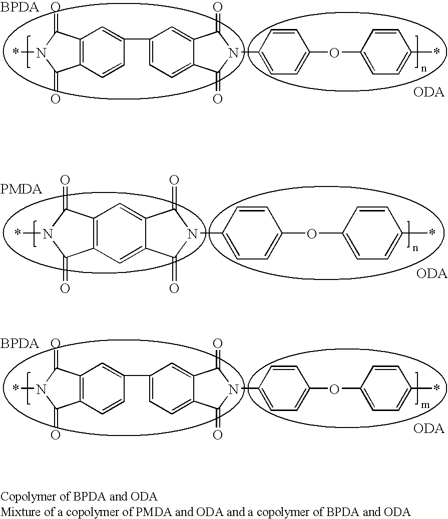

The intermediate transfer belt according to the invention preferably has a humidity expansion coefficient of 45 ppm/% RH or less and a thermal expansion coefficient of 45 ppm/K or less.

It is possible to prevent local expansion of the intermediate transfer belt and give a stabilized belt-traveling, when the expansion coefficients are in the ranges above. As a result, it is possible to obtain a high-quality transferred image, independent of the environment, temperature and humidity, inside the image-forming device.

The humidity expansion coefficient is more preferably 30 ppm/% RH or less, and the thermal expansion coefficient, 30 ppm/K or less.

The humidity expansion coefficient is determined in the following manner:

First, a sample is prepared by cutting an intermediate transfer belt into a piece having a width of 25.4 mm and a length of 210 mm. Then, the length direction of the sample is in parallel with the direction of the circumferential edge of the intermediate transfer belt. The sample is connected to a chuck of 0.240 kg in mass at its lower region and to another chuck to be fixed to a supporting stand at its upper region; and the sample is held vertically at a chuck distance of 149 mm. The expansion or shrinkage of the sample, which corresponds to the vertical movement of the lower chuck, is determined by the vertical displacement of the lower belt region as measured by a microgauge fixed on the supporting stand. The expansion/shrinkage amount is expressed by a numerical value with plus (+) when the test piece expanded or with minus (−) when shrunk. A microgauge ID-S1012 (minimum scale: 0.01 mm, precision: 0.02 mm) manufactured by Mitsutoyo Corp. may be used for that purpose. The sample is left as it is held vertically in a constant-temperature/humidity bath in an environment at (a) 22° C. and 55% RH for 24 hours; and the sample length is corrected by using the expansion/shrinkage ΔLa of the sample then. Then, the expansion/shrinkage of the sample, ΔL20 or ΔL85, is determined after it is left in an environment at (b) 35° C. and 20% RH or (c) 35° C. and 85% RH for 24 hours. The humidity expansion coefficient H is represented by the following Formula (2):
H (ppm/% RH)=10⁶×(ΔL85−ΔL20)₍ₘₘ₎/(149−ΔLa)₍ₘₘ₎/(85−20)_{(% RH)} (2)

The measurement was repeated for a total of six times, thrice after the conditional change of (b) to (c) and thrice after conditional change of (c) to (b), and the average is designated as the humidity expansion coefficient.

On the other hand, the thermal expansion coefficient of the intermediate transfer belt is determined in the following manner:

First, a sample having a width of 3.0 mm and a length of 10.0 mm is cut off from an intermediate transfer belt. The length direction of the sample is in parallel with the direction of the circumferential edge of the intermediate transfer belt. The sample is heated from room temperature to 200° C. at a programmed heating rate of 5°/minute and then cooled to 100° C., and the thermal expansion coefficient is determined from the sample length during cooling. A thermomechanical analyzer TMA-50 manufactured by Shimadzu Corporation may be used for measurement. The thermal expansion coefficient is calculated according to the Formula shown in the “Testing method for linear thermal expansion coefficient of plastics by thermomechanical analysis” specified by JIS K7197 (1991), the disclosure of which is incorporated by reference herein.

The intermediate transfer belt according to the invention preferably has a surface roughness Ra in the range of 0.010 to 0.050 μm, more preferably in the range of 0.010 to 0.040 μm, from the viewpoints of the transfer and cleaning efficiency of the toner image. The surface roughness Ra can be controlled by selecting the kind of the polyimide resin used properly and adjusting the amount of the polyaniline blended in the range above.

The surface roughness Ra is the arithmetic mean roughness specified in JIS B0601 (2001), the disclosure of which is incorporated by reference herein.

In the invention, the surface roughness Ra is determined by pre-processing a test sample obtained by cutting off part of a belt base material prepared by the method (A) or (B) described in preparation of intermediate transfer belt (1) by PtAu sputtering, and analyzing the sample by using an electron microscope (S-4200, manufactured by Hitachi) and a three-dimensional shape analyzer (RD-500, manufactured by DKL). The test conditions are as follows: accelerating voltage: 10 kv, magnification: 1,000, working distance: 15 mm; and a band pass filter at an FFT of 5 to 200 Hz is used during data processing.

In addition, the intermediate transfer belt according to the invention preferably has a micro-glossiness, as determined at an incident angle of 75° to the transfer face, in the range of 95 to 120 glossiness units, more preferably in the range of 100 to 120 glossiness units, for improving the contrast between the intermediate transfer belt and the toner patch image for automatic density adjustment formed on the intermediate transfer belt. The microglossiness can be controlled by selecting the kind of the polyimide resin used properly and adjusting the amount of the polyaniline blended in the range above.

In the invention, the micro-glossiness is determined by using Microgloss 75° (Type 4553, manufactured by BYK Gardner).

In addition, the intermediate transfer belt according to the invention preferably has a surface micro-hardness of 25 mN/μm² or less, more preferably 20 mN/μm² or less, for reducing the pressure applied onto the developer (toner) during transfer and reducing disconnection of line images (hollow character).

The micro-hardness is determined in the following manner: First, an intermediate transfer belt is cut to a piece of 6 mm square, and the small piece is bonded onto a glass plate with an instant adhesive with its face receiving the image during image transfer facing upward. The dynamic micro-hardness of the surface layer of this sample is determined by using a micro-hardness meter DUH-201s (manufactured by Shimadzu Corporation).

The “dynamic micro-hardness” is determined not by the method commonly used in hardness measurement of metal materials, such as Vickers hardness, of determining the diagonal length of dents, but by measuring the extent of penetration of its indenter into sample. When the test load is designated as P (mN) and the penetration of the indenter into sample (penetration depth) as D (μm), the dynamic micro-hardness DH (mN/μm²) is defined by the following Formula (3):
DH=αP/D² (3)

In the Formula (3), α is a constant depending on the shape of the indenter, and α is 3.8584 when the indenter used is a triangular pyramid indenter.

The surface micro-hardness is a hardness calculated from the load during penetration of the indenter and the penetration depth, and represents a strength property of the sample including both plastic and elastic deformations. In addition, the test area is very small, and the method allows more accurate determination of the hardness in the area almost close to the size of toner particle. Test conditions are summarized below, and an average of 10 results at arbitrary points of sample is designated as the dynamic micro-hardness of the sample.

Measurement environment: 22° C., 55% RH

Indenter used: Triangular pyramid indenter

Test mode: 3 (soft material test)

Test load: 0.70 gf

Load velocity: 0.014500 gf/sec

Retention period: 5 sec

The intermediate transfer belt according to the invention preferably has a tensile elastic modulus of 2,500 MPa or more, more preferably 3,500 MPa or more, for prevention of breakage of belt and improvement in color registration. The tensile elastic modulus is preferably greater, but practically, preferably 8,000 MPa or less, more preferably 6,000 MPa or less, from the viewpoint of the durability of the image-forming device carrying the intermediate transfer belt. It is possible to control the tensile elastic modulus of the intermediate transfer belt in a suitable range, by properly selecting the chemical structure of the resin material used; and a resin material containing a greater number of aromatic ring structures is more effective in improving the Young's modulus.

The tensile elastic modulus of an intermediate transfer belt left and conditioned in environments at 28° C. and 85% RH and/or at 22° C. and 55% RH for 24 hours or more is preferably controlled in the favorable range above.

The tensile elastic modulus can be determined in the following manner: The test piece used is the same as the test piece Type 2 specified by JIS K7127 (1999), the disclosure of which is incorporated by reference herein.

A sample is prepared by cutting an intermediate transfer belt according to the invention into a test piece having a width of 10 mm and a length of 200 mm. The length direction is in parallel with the direction of the circumferential edge of the intermediate transfer belt. The tensile elastic modulus is determined at an initial chuck distance of 100 mm±5 mm and a stress rate of 10 mm/minute, and calculated according to the method of JIS K7127 (1999).

The surface resistivity of the intermediate transfer belt according to the invention is preferably 1×10¹⁰ to 1×10¹⁴ Ω/cm² and more preferably, 1×10¹¹ to 1×10¹³ Ω/cm². A surface resistivity of higher than 1×10¹⁴ Ω/cm² may cause easier release discharge in the post-nip region where the image holding member in the primary transfer area is separated from the intermediate transfer belt, and consequently, deterioration in quality of the image, such as white deletion, in the electrically discharged area. On the other hand, a surface resistivity of less than 1×10¹⁰ Ω/cm² may lead to increase in the electric-field strength in the pre-nip portion and deterioration in the image-quality such as graininess in the pre-nip portion because of the gap discharge there.

Thus, a surface resistivity in the range above prevents the white deletion caused when the surface resistivity is higher and the deterioration in image quality caused when the surface resistivity is lower.

In addition, the volumetric resistivity of the intermediate transfer belt according to the invention is preferably 1×10⁸ to 1×10¹⁴ Ωcm and more preferably 1×10⁹ to 1×10¹³ Ωcm. A volumetric resistivity of less than 1×10⁸ Ωcm makes the electrostatic force, which preserves the charge on the unfixed toner image transferred from the image holding member onto the intermediate transfer belt, weaker and results in scattering of the toner (blurring) caused by the electrostatic repulsive force among toner particles and the electrostatic force caused by the fringe electric field surrounding image; and thus, such a transfer belt may give an image higher in noise. On the other hand, a volumetric resistivity of more than 1×10¹⁴ Ωcm leads to charging of the intermediate transfer body surface by the transfer electric field during primary transfer due to increase in charge coercive force, and thus, such a transfer belt may demand an additional charge eliminating mechanism.

Thus, the intermediate transfer belt having a volumetric resistivity in the range above eliminates the problems of toner scattering and of demanding an additional charge eliminating mechanism.

<Image-Forming Device>

The image-forming device according to the invention is not particularly limited, if it is an image-forming device of the intermediate transfer process having the intermediate transfer belt according to the invention described above. In particular, preferable is an image-forming device having an image holding member where an electrostatic latent image corresponding to image information is formed, a developing device visualizing the electrostatic latent image formed on the image holding member as a toner image with a toner, an intermediate transfer belt where the toner image formed on the image holding member is primary-transferred, and a bias mechanism which secondary-transfers the unfixed toner image on the intermediate transfer belt onto a recording medium, wherein the intermediate transfer belt according to the invention described above is used as the intermediate transfer belt.

As described above, the intermediate transfer belt according to the invention is superior in surface smoothness, and application thereof to an image-forming device is effective in providing high-quality transferred images reliably.

Hereinafter, an example of the configuration of the image-forming device according to the invention equipped with the intermediate transfer belt according to the invention will be described in detail with reference to drawings.

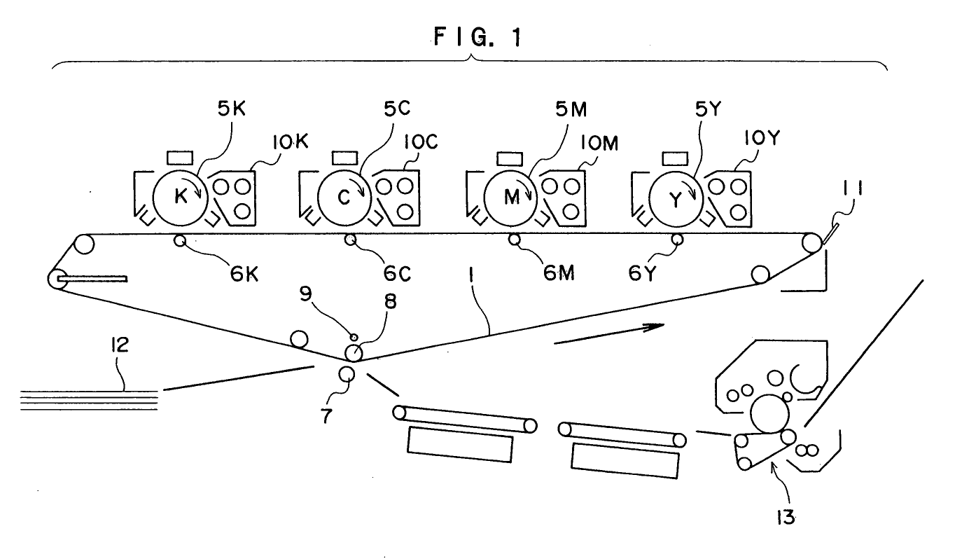

FIG. 1 is a schematic view illustrating the main region of an image-forming device according to the invention. The image-forming device shown in FIG. 1 is a high speed/many sheets of paper output machine having four photoreceptor drums for different colors therein. 5Y, 5M, 5C, and 5K each represent a image holding member photoreceptor drum (hereinafter, Y, M, C, and K represent respectively yellow, magenta, cyan, and black); 1, an intermediate transfer belt; 6Y, 6 M, 6C, and 6K, a primary transfer roll; 7, a secondary transfer roll; 8, a backup roll; 9, a contact roll; 10Y, 10 M, 10C, and 10K, a developing device; 11, a transfer belt cleaner; 12, a recording paper; and 13, a fixing unit.

In the Figure, the photoreceptor drum 5Y rotates clockwise, and the surface thereof is charged uniformly by a charging device not shown in the Figure. An electrostatic latent image in the first color (Y) is formed on the charged photoreceptor drum 5Y by an image-writing unit such as laser-writing device.

The electrostatic latent image is visualized by development with a toner by the developing device 10Y into a toner image. The toner image reaches the primary transfer region by rotation of the photoreceptor drum 5Y, where the toner image is transferred onto an intermediate transfer belt 1 rotating counterclockwise (arrow) while an electric field in the opposite direction is applied from a primary transfer roll 6Y to the toner image.

Then, a toner image (M) in the second color, a toner image (C) in the third color, and a toner image (K) in the fourth color are formed similarly in sequence and overlaid on the intermediate transfer belt 1, to give a multiplex toner image.

The multiplex toner image transferred on the intermediate transfer belt 1 advances to a secondary transfer region where a secondary transfer roll 7 is installed by rotation of the intermediate transfer belt 1.

The secondary transfer region include a secondary transfer roll 7 placed at a place facing the surface of the intermediate transfer belt 1 carrying the toner image, a backup roll 8 placed on the rear face of the intermediate transfer belt 1 and facing the secondary transfer roll 7, and a contact roll 9 rotating in contact with the backup roll 8.

In the secondary transfer region, the toner image is transferred onto a recording paper 12 by electrostatic repulsion, as a bias (transfer voltage) having the same polarity as the toner image is applied to the contact roll 9 in contact with backup roll 8, which faces the secondary transfer roll 7 via the intermediate transfer belt 1.

The recording paper 12 is withdrawn from a stack of paper in a recording paper tray (not shown in the Figure) one by one by a pickup roller (not shown in the Figure), and fed by a feed roll (not shown in the Figure) into the gap between the intermediate transfer belt 1 and the secondary transfer roll 7 in the secondary transfer region at a predetermined timing.

The toner image on the intermediate transfer belt 1 is transferred onto the supplied recording paper 12, by the pressure between the secondary transfer roll 7 and the backup roll 8, the rotation of the intermediate transfer belt 1, and the transfer voltage applied to the contact roll 9.

The recording paper 12 carrying the transferred toner image is sent to a fixing unit 13, where the toner image is fixed under heat and pressure into a permanent image.

The intermediate transfer belt 1 after transfer of the multiplex toner image onto the recording paper 12 is cleaned with a belt cleaner 11 placed downstream of the secondary transfer region for removal of residual toner, before next transfer. Foreign matters such as toner particles and dusting deposited on the secondary transfer roll 7 during transfer are also removed by brush cleaning (not shown in the Figure).

In the case of a single-color image, the toner image after primary transfer is immediately secondary-transferred and sent to the fixing unit, but in the case of a multicolor image, toner images in plural colors are overlaid accurately at the same place on the primary transfer, by synchronized rotation of the intermediate transfer belt 1 and the photoreceptor drums 5Y, 5M, 5C, and 5K.

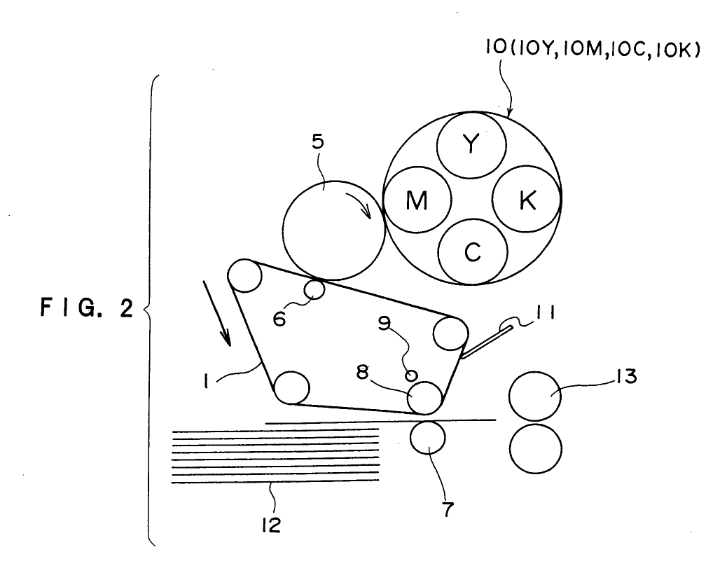

FIG. 2 is a schematic view of the main region of another image-forming device according to the invention different from that in FIG. 1 in its process. 5 represents a image holding member photoreceptor drum; 1, an intermediate transfer belt; 6, a primary transfer roll; 7, a secondary transfer roll; 8, a backup roll; 9, a contact roll; 10Y, 10 M, 10C, and 10K, each a developing device (hereinafter, Y, M, C, and K represent respectively yellow, magenta, cyan, and black); and 11, a transfer belt cleaner.

In the FIG. 2, the photoreceptor drum 5 rotates clockwise, and the surface thereof is charged uniformly by a charging device not shown in the Figure. An electrostatic latent image in the first color (for example, Y) is formed on the charged photoreceptor drum 5 by an image-writing unit such as laser-writing device.

The electrostatic latent image is visualized by development with a toner by the developing device 10Y into a toner image. The toner image reaches the primary transfer region by rotation of the photoreceptor drum 5, where the toner image is transferred onto an intermediate transfer belt 1 rotating counterclockwise (arrow) while an electric field in the opposite direction is applied from the primary transfer roll 6 to the toner image.

Then, a toner image (M) in the second color, a toner image (C) in the third color, and a toner image (K) in the third color are formed similarly in sequence and overlaid on the intermediate transfer belt 1, to give a multiplex toner image.

The multiplex toner image transferred on the intermediate transfer belt 1 advances to a secondary transfer region where a secondary transfer roll 7 is installed by rotation of the intermediate transfer belt 1.

The secondary transfer region include a secondary transfer roll 7 placed at a place facing the surface of the intermediate transfer belt 1 carrying the toner image, a backup roll 8 placed on the rear face of the intermediate transfer belt 1 and facing the secondary transfer roll 7, and a contact roll 9 rotating in contact with the backup roll 8.

In the secondary transfer region, the toner image is transferred onto a recording paper 12 by electrostatic repulsion while a bias (transfer voltage) having the same polarity as the toner image is applied to the contact roll 9 in contact with the backup roll 8, which faces the secondary transfer roll 7 via the intermediate transfer belt 1.

The recording paper 12 is withdrawn from a stack of paper in a recording paper tray (not shown in the Figure) one by one by a pickup roller (not shown in the Figure), and fed by a feed roll (not shown in the Figure) into the gap between the intermediate transfer belt 1 and the secondary transfer roll 7 in the secondary transfer region at a predetermined timing.

The toner image on the intermediate transfer belt 1 is transferred onto the supplied recording paper 12, by the pressure between the secondary transfer roll 7 and the backup roll 8 and the rotation of the intermediate transfer belt 1.

The recording paper 12 carrying the transferred toner image is sent to the fixing unit 13, where the toner image is fixed under heat and pressure into a permanent image.

The intermediate transfer belt 1 after transfer of the multiplex toner image onto the recording paper 12 is cleaned with a belt cleaner 11 placed downstream of the secondary transfer region for removal of residual toner, before next transfer. Foreign matters such as toner particles and dusting deposited on the secondary transfer roll 7 during transfer are also removed by brush cleaning (not shown in the Figure).

In the case of a single-color image, the toner image after primary transfer is immediately secondary-transferred and sent to the fixing unit, but in the case of a multicolor image toner images in plural colors are overlaid accurately at the same place on the primary transfer by synchronized rotation of the intermediate transfer belt 1 and the photoreceptor drum 5.

Some embodiments of the invention are outlined below.

According to an aspect of the invention, an intermediate transfer belt comprises a polyimide resin comprising a polyaniline, wherein the absolute maximum length of the largest particle of the polyaniline is approximately 10.0 μm or less.

The particles of polyaniline have: a 50 percentile particle diameter (number basis) in the range of approximately 0.05 to 3.0 μm; and a 90 percentile particle diameter (number basis) of one to two times the 50 percentile particle diameter (number basis).

The polyimide resin further comprises a filler and the absolute maximum length of the largest particle of the polyaniline (a) and the absolute maximum length of the largest filler particle (b) satisfy the relationship represented by the following Formula (1):
10.0 μm≧Absolute maximum length (a)>Absolute maximum length (b)≧0.1 μm (1)

The filler is a filler selected from silica, alumina, mica, talc, barium sulfate, tin oxide, antimony-doped tin oxide, indium-doped tin oxide, antimony-doped titanium oxide, and carbon black.

The polyimide resin comprises a copolymer of 3,3′,4,4′-biphenyltetracarboxylic dianhydride and 4,4′-diaminodiphenylether.

The polyimide resin comprises a copolymer of 3,3′,4,4′-biphenyltetracarboxylic dianhydride and 4,4′-diaminodiphenylether and a copolymer of pyromellitic dianhydride and 4,4′-diaminodiphenylether.

The polyimide resin further comprises a dopant for making the polyaniline conductive.

The dopant is a protonic acid having an acid dissociation constant pKa of approximately 4.8 or less.

The polyaniline is a self-doping polyaniline.

The surface roughness Ra thereof is in the range of approximately 0.010 to 0.050 μm.

The micro-glossiness of the transfer face thereof at an incident angle of 75° is in the range of approximately 95 to 120 gloss units.

The humidity expansion coefficient thereof is approximately 45 ppm/% RH or less and the thermal expansion coefficient thereof is approximately 45 ppm/K or less.

The surface micro-hardness thereof is approximately 25 mN/μm² or less.

The tensile elastic modulus thereof is approximately 2,500 MPa or more.

The surface resistivity thereof is in the range of approximately 1×10¹⁰ to 1×10¹⁴ Ω/cm².

The volumetric resistivity thereof is in the range of approximately 1×10⁸ to 1×10¹⁴ Ωcm.

According to another aspect of the invention, an image-forming device comprises an image holding member whereon an electrostatic latent image corresponding to image information is formed, a developing device making visible the electrostatic latent image formed on the image holding member as a toner image with a toner, an intermediate transfer belt whereon the toner image formed on the image holding member is primary-transferred, and a bias mechanism which secondary-transfers the unfixed toner image on the intermediate transfer belt onto a recording medium, wherein

the intermediate transfer belt is the intermediate transfer belt comprising a polyimide resin containing polyaniline, wherein the absolute maximum length of the largest particle of the polyaniline is approximately 10.0 μm or less.

According to another aspect of the invention, a method of producing an intermediate transfer belt comprises:

pulverizing a polyaniline in an undoped state into particles having a 50 percentile particle diameter (volume basis) in the range of approximately 0.05 to 3.0 μm and a 90 percentile particle diameter (volume basis) in the range of one to two times the 50 percentile particle diameter (volume basis);

adding a dopant for making the polyaniline conductive thereto;

blending the mixture with a polyamic acid; and

drying and sintering the mixture.

According to another aspect of the invention, a method of producing an intermediate transfer belt comprises:

pulverizing a self-doping polyaniline into particles having a 50 percentile particle diameter (volume basis) in the range of approximately 0.05 to 3.0 μm and a 90 percentile particle diameter (volume basis) in the range of one to two or less times the 50 percentile particle diameter (volume basis);

mixing the particles with a polyamic acid; and

drying and sintering the mixture.

### EXAMPLES

Plural Examples of the present invention and Comparative Examples corresponding to these Examples will be described below. These Examples are aimed only for exemplification, and it should be understood that the scope of the invention is not restricted thereby.

### Example 1

<Preparation of Polyamic Acid Solution (A-1)>

3,3′,4,4′-biphenyltetracarboxylic dianhydride (BPDA) and pyromellitic dianhydride (PMDA) is added to a DMAc solution of 4,4′-diaminodiphenylether (ODA), and the mixture is stirred sufficiently under nitrogen atmosphere. The molar ratio of ODA:BPDA:PMDA is 1.00:0.55:0.45, and thus, a polyamic acid solution (A-1) at a concentration of 20 mass % is obtained.

<Preparation of Undoped Polyaniline and Dopant>

Panipol PA manufactured by Panipol is made available as undoped polyaniline.

Separately, para-phenolsulfonic acid in an amount of 30% by mole equivalence of the undoped polyaniline (in other words, 60% mole equivalences with respect to 100% of half of the undoped polyaniline) is made available as dopant. The para-phenolsulfonic acid is added to and stirred in DMAc solvent under nitrogen atmosphere, to give a homogenous dopant solution at a concentration of 5 mass %.

<Preparation of Polyaniline Dispersion (B-1)>

An undoped polyaniline, Panipol PA manufacture by Panipol, is pulverized in a dry jet mill. The dry jet mill used is a counter jet mill (type 100AFG) manufactured by Hosokawamicron Corporation.

The counter jet mill contains (1) a raw material-supplying unit FTS-20, (2) a counter jet mill 100AFG, (3) a product-collecting unit-1 (Φ100 cyclone), (4) a product-collecting unit-2 (P-bag, filtration area: 2.3 square meters), and (5) an exhaust blower. Main conditions in pulverization are as follows: pulverization air flow: 100 cubic meters per minute, air pressure: 600 kPa, and classification rotational velocity: 20,000 rpm.

The polyaniline collected then in the product-collecting unit-2 (P-bag) is designated as the first polyaniline particles, and a small amount thereof is dispersed in ethanol. Analysis of the particle size distribution of the first polyaniline particle shows: that the 50 percentile particle diameter (volume basis) is 1.4 μm; the 90 percentile particle diameter (volume basis), 2.4 μm; and the 100 percentile particle diameter (volume basis), 5.9 μm.

250 parts by mass of the pulverized first polyaniline particles and 25 parts by mass of PVP (polyvinylpyrrolidone) are added gradually under nitrogen atmosphere to the dopant solution at a concentration of 5 mass %, a predetermined amount with respect to 250 parts of polyaniline, and the mixture is stirred uniformly, to give a doped polyaniline dispersion (B-1).

<Preparation of Coating Solution (C-1)>

The polyamic acid solution (A-1) and the doped polyaniline dispersion (B-1) obtained by the method above are mixed uniformly, to give a coating solution. The solid-content mass ratio of the doped polyaniline (PAn) to the polyamic acid (PAA), PAn:PAA, is 12:88. DMAc solvent is added as needed to adjust its viscosity in the range suitable for coating.

<Preparation of Endless Belt>

The coating solution obtained is coated uniformly on the inner surface of a cylindrical SUS mold having an inner diameter of 365.5 mm and a length of 600 mm. The inner surface of the cylindrical mold is previously coated with a fluorine-based releasing agent for facilitating removal of the belt after preparation.

Then, the coated film is dried at a temperature of 120° C. for 30 minutes while the metal mold is rotated. After drying, the metal mold is baked in an oven at 320° C. approximately for 30 minutes, allowing the imide conversion reaction to proceed.

The metal mold is then cooled to room temperature, and the resin is removed from the metal mold, to give an endless belt.

Both ends of the endless belt obtained are cut off, to give an intermediate transfer belt having a peripheral length of 1,148 mm and a width 369 mm. The thickness of the intermediate transfer belt is 0.08 mm.

### Example 2

An intermediate transfer belt of Example 2 is prepared in a similar manner to Example 1, except that the polyaniline dispersion (B-1) used in Example 1 is replaced with the following polyaniline dispersion (B-2).

<Preparation of Polyaniline Dispersion (B-2)>

Part of the polyaniline particles collected in the product-collecting unit-1 (Φ100 cyclone) in the pulverized polyaniline obtained during preparation of the polyaniline dispersion (B-1) is collected as the second polyaniline particles; and a small portion thereof is dispersed in ethanol. Analysis of the particle size distribution of the second polyaniline particles shows that the 50 percentile particle diameter (volume basis) is 2.7 μm; the 90 percentile particle diameter, 4.3 μm, and the 100 percentile particle diameter (volume basis), 7.7 μm.

Then, 250 parts by mass of the pulverized second polyaniline particles and 25 parts by mass of PVP (polyvinylpyrrolidone) are added gradually under nitrogen atmosphere to the dopant solution at a concentration of 5 mass %, a predetermined amount with respect to 250 parts by mass of polyaniline, and the mixture is stirred uniformly, to give a doped polyaniline dispersion (B-2).

### Comparative Example 1

An intermediate transfer belt of Comparative Example 1 is prepared in a similar manner to Example 1, except that the polyaniline dispersion (B-1) used in Example 1 is replaced with the following polyaniline dispersion (B-3).

<Preparation of Polyaniline Dispersion (B-3)>

Panipol PA manufacture by Panipol is used as it is without pulverization. A small amount of the Panipol PA is collected and dispersed in ethanol. Analysis of the particle size distribution of the Panipol PA shows: that the 50 percentile particle diameter (volume basis) is 15.5 μm; the 90 percentile particle diameter (volume basis), 25.3 μm; and the 100 percentile particle diameter (volume basis), 48.5 μm.

Then, 25 parts by mass of PVP (polyvinylpyrrolidone) and 250 parts by mass of Panipol PA are added gradually under nitrogen atmosphere to the dopant solution at a concentration of 5 mass %, a predetermined amount with respect to 250 parts by mass of polyaniline, and the mixture is stirred uniformly, to give a doped polyaniline dispersion (B-3).

### Comparative Example 2

An intermediate transfer belt of Comparative Example 2 is prepared in a similar manner to Example 1, except that the polyaniline dispersion (B-1) used in Example 1 is replaced with the following polyaniline dispersion (b-1) and the solid-content mass ratio of polyaniline to polyamic acid PAS:PAA is changed to 10:90.

<Preparation of Polyaniline Dispersion (b-1)>

Panipol F manufactured by Panipol, a doped polyaniline (Emeraldine Salts), is pulverized similarly to the polyaniline dispersion (B-1) in Example 1 in a counter jet mill (type 100AFG) manufactured by Hosokawamicron Corporation.

Part of the polyaniline particles collected in the product-collecting unit-2 (P-bag) are dispersed in ethanol, and analysis of the particle size distribution of the polyaniline particles shows that the 50 percentile particle diameter (volume basis) is 3.2 μm; the 90 percentile particle diameter (volume basis), 7.4 μm, and the 100 percentile particle diameter (volume basis), 30.2 μm. Then, 15 parts by mass of PVP (polyvinylpyrrolidone) is added under nitrogen atmosphere to 1,700 parts by mass of DMAc; the mixture is blended uniformly; and 250 parts by mass of the pulverized Panipol F, a doped polyaniline (Emeraldine Salt), is added gradually to the solution, to give a liquid mixture containing the doped polyaniline (b-1) at a concentration of 13 mass %.

### Comparative Example 3

An intermediate transfer belt of Comparative Example 3 is prepared in a similar manner to Example 1, except that the polyaniline dispersion (B-1) used in Example 1 is replaced with the following polyaniline dispersion (b-2).

<Preparation of Polyaniline Solution (b-2)>

250 parts by mass of Panipol PA manufacture by Panipol is added under nitrogen atmosphere to 1,700 parts by mass of DMAc solvent, and the mixture is stirred uniformly, to give a polyaniline solution at a concentration of 13 mass %.

Then, a dopant (para-phenol sulfonic acid) is added to and stirred in the DMAc solvent, to give a homogeneous dopant solution at a concentration of 5 mass %.

A dopant solution containing Panipol PA at a concentration of 5 mass %, or in an amount of 60% with respect to 100% of Panipol PA because half of the Panipol PA is used for doping, is added thereto, and the mixture is stirred uniformly, to give a doped polyaniline solution (b-2).

[Evaluation]

First, the absolute maximum length of the largest polyaniline particle, the 50 percentile particle diameter (number basis) and the 90 percentile particle diameter (number basis) of polyaniline particles (number basis) in each of the intermediate transfer belts obtained in Examples 1 and 2 and Comparative Examples 1 to 3 are determined, and the particle size distribution is also calculated from the 50 percentile particle diameter and 90 percentile particle diameter.

The “absolute maximum length of the largest polyaniline particle” is determined by collecting nine samples at respectively three points in the length direction and three points in the width direction (the intervals in the width and length directions are almost the same), and measuring the absolute maximum lengths of the largest polyaniline particle in six visual fields of each sample. The specific measuring method is the same as that described above.

The “50 percentile particle diameter (number basis) and the 90 percentile particle diameter (number basis) of polyaniline particles” are determined by collecting nine samples at respectively three points in the width direction and three points in the length direction and measuring the samples in a similar manner to above.

“Evaluation of Appearance (Yield)”

The appearance (transfer face) of each of the intermediate transfer belts obtained in Examples 1 and 2, and Comparative Examples 1 to 3 is evaluated, and the belt having no surface defects such as raised spots or dents is regarded to satisfy the requirement in appearance. A criteria sample is used for evaluation of the surface defects such as raised spot and dent. A raised spot having a diameter of 300 μm and a height of 20 μm or more and a dent visually detectable having a depth of 20 μm or more independent of the outer diameter (usually, 10 mm or less) are regarded as surface defects. Table 1 shows the number of the samples satisfying the requirement in 20 samples.

The evaluation criteria for the number of samples satisfying the requirement in Table 1 are as follows:

“G1”: 19 or more samples acceptable out of 20

“G2”: 17 to 18 samples acceptable out of 20

“G3”: 16 or less samples acceptable out of 20

The “electrical properties”, “surface physical properties”, and “quality of transferred image” described below are determined by using three samples satisfying the requirement in belt appearance in the Examples and Comparative Examples.

“Evaluation of Electrical Properties”

(Measurement of Electric Resistivity)

The surface resistivity of intermediate transfer belt is determined by using R8340A digital ultrahigh-resistance/minute-current ammeter (manufactured by Advantest Corporation), and double-ring-electrode UR probe MCP-HTP12 and Resitable UFL MCP-ST03 (both, manufactured by Dia Instruments) respectively connected R8340A at the modified connection units.

The surface resistivity of each of the three intermediate transfer belts arbitrarily sampled is determined at 24 points, respectively six points in the width direction×four points in the length direction, and the result is shown in the form of average±range in Table 1. After measurement, there is no difference between the three belts.

The Resitable UFL MCP-ST03 is placed inside the intermediate transfer belt with its fluoroplastic-surfaced face facing upward, and the UR probe MCP-HTP12 double electrode is brought into contact with the transfer face of the belt (outside of the belt). A uniform load is applied on the transfer face of the intermediate transfer belt by placing a mass of 2.00±0.10 kg (19.6±1.0 N) on the UR probe MCP-HTP12.

The R8340A digital ultrahigh-resistance/minute-current ammeter probe is used under the condition of a charge time of 30 sec, a discharge time of 1 sec and an applied voltage of 100 V.

When the surface resistivity then is designated as ρs, the reading of the R8340A digital ultrahigh-resistance/minute-current ammeter as R, and the surface resistivity correction coefficient of the UR probe MCP-HTP12 as RCF(S), because RCF(S) is 10.00 according to the catalog of the “resistance meter series products” of Mitsubishi Chemical Corp., the surface resistivity is expressed by the following Formula (4):
ρs [Ω/cm²]=R×RCF(S)=R×10.00. (4)
(Measurement of Volumetric Resistivity)

The volumetric resistivity of the intermediate transfer belt is determined by using R8340A digital ultrahigh-resistance/minute-current ammeter (manufactured by Advantest Corporation) and double-ring-electrode UR probe MCP-HTP12 and Resitable UFL MCP-ST03 (both, manufactured by Dia Instruments) respectively connected to R8340A at the modified connecting units.

In a similar manner to the surface resistivity measurement above, the volumetric resistivity of each of three intermediate transfer belts arbitrarily sampled is also determined at 24 points, respectively six points in the width direction×four points in the length direction, and the result is shown in the form of average±range in Table 1. After measurement, there is no difference between the three belts. The intermediate transfer belt used for measurement of volumetric resistivity may be the same as the intermediate transfer belt used in measurement of surface resistivity.

The Resitable UFL MCP-ST03 is placed inside the intermediate transfer belt with its metal face facing upward, and the double electrode unit of the UR probe MCP-HTP12 is brought into contact with the transfer face of the belt (outside of the belt). A uniform load is applied on the transfer face of the intermediate transfer belt by placing a mass of 2.00±0.10 kg (19.6±1.0 N) on the UR probe MCP-HTP12.

The R8340A digital ultrahigh-resistance/minute-current ammeter probe is used under the condition of a charge time of 30 sec, a discharge time of 1 sec and an applied voltage of 100 V.

When the volumetric resistivity then is designated as ρv, the thickness of the intermediate transfer body as t (μm), the reading of the R8340A digital ultrahigh-resistance/minute-current ammeter as R, and the volumetric-resistivity correction coefficient of the UR probe MCP-HTP12 as RCF(V), because RCF(V) is 2.011 according to the catalog of the “resistance meter series products” of Mitsubishi Chemical Corp., the volumetric resistivity is expressed by the following Formula (5):
ρv [Ω·cm]=R×RCF(V)×(10,000/t)=R×2.011×(10,000/t). (5)

The evaluation criteria for the surface and volumetric resistivities in Table 1 are as follows:

“G1”: The range in average±range is not larger than 0.1 (satisfactory)

“G2”: The range in average +range is more than 0.1 and 0.2 or less (practically allowable)

“G3”: The range in average±range is more than 0.2 (unsatisfactory)

“Evaluation of Surface Physical Properties”

(Measurement of Surface Roughness Ra)

The surface roughness Ra is determined by measuring four points on each of three intermediate transfer belts arbitrarily sampled according to the method described above. Table 1 shows the range from the minimum to maximum value.

The evaluation criteria for the surface roughness Ra shown in Table 1 are as follows:

“G1”: Maximum value is 0.05 μm or less (satisfactory)

“G2”: Maximum value is more than 0.05 μm and 0.07 μm or less (demanding some adjustment of the system)

“G3”: Maximum value is more than 0.07 μm (unsatisfactory)

(Measurement of Micro-Glossiness)

The micro-glossiness at a incident angle of 75° of each of three intermediate transfer belts arbitrarily sampled is also determined at 24 points, respectively six points in the width direction×four points in the length direction, and the result is shown by the range from the minimum to maximum value in Table 1.

The evaluation criteria for the micro-glossiness shown in Table 1 are as follows:

“G1”: The minimum is 95 gloss unit or more (satisfactory)

“G2”: The minimum is 90 gloss units or more and less than 95 glossiness units (demanding some adjustment of the system)

“G3”: The minimum is less than 90 gloss units (unsatisfactory)

(Measurement of Sharpness)

The sharpness is determined at one point of each of three intermediate transfer belts arbitrarily sampled according to the method shown below. Table 1 shows the result of the belt worst in evaluation.

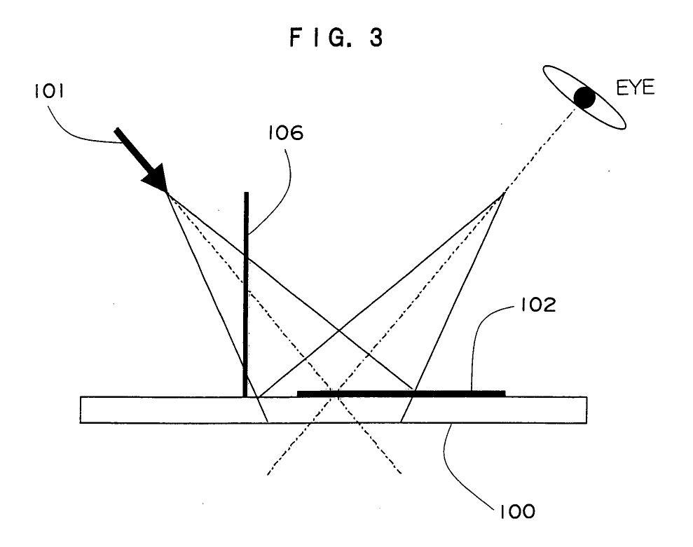

First as shown in FIG. 3, an intermediate transfer belt sample 102 is placed on a surface plate 100; a light from a light source 101 (fluorescent lamp) is irradiated at a predetermined angle, via a standard lattice plate 106 placed perpendicular to the surface plate 100, onto the transfer face of the intermediate transfer belt; and the deformation and sharpness of the lattice formed on the transfer face are evaluated by visual observation. The standard lattice plate 106 has a lattice of 10 mm square.

The evaluation criteria for the sharpness shown in Table 1 are as follows:

“G1”: Minimum lattice deformation, and distinct thin lattice line (satisfactory)

“G2”: Minimum lattice deformation minimum, but blurred slightly thicker lattice line (practically allowable)

“G3”: Small lattice deformation, but blurred thick lattice line (unsatisfactory)

“Evaluation of the Quality of Transferred Image”

The following graininess, white deletion, and cleaning defect are evaluated, while the intermediate transfer belt obtained is placed in an image-forming device, DocuCenter C6550 I manufactured by Fuji Xerox Co., Ltd., as is shown in FIG. 1, The paper used is an A4-size J paper (manufactured by Fuji Xerox Office Supply Co., Ltd.).

(Evaluation of Half-Tone Graininess)

The graininess is evaluated by forming a 20% magenta half-tone image on three intermediate transfer belts arbitrarily sampled and visually observing the images obtained. Table 1 shows the result of the belt worst in evaluation.

The evaluation criteria for the graininess shown in Table 1 are as follows:

“G1”: Favorable (satisfactory, smooth)

“G2”: Somewhat dissatisfied (practically allowable)

“G3”: Very dissatisfied (unsatisfactory)

(Evaluation of White Deletion)

The white deletion is evaluated by forming a 30% magenta half-tone image on three intermediate transfer belts arbitrarily sampled and visually observing the images obtained whether there is white deletion caused by the belt. Table 1 shows the result of the belt worst in evaluation.

The evaluation criteria for the white deletion shown in Table 1 are as follows:

“G1”: No white deletion

“G3”: Blurred or rain drops-like white deletion observed.

(Evaluation of Cleaning Defect)

The cleaning defect is evaluated by forming 10% half-tone images in magenta, cyan, yellow, and black on three intermediate transfer belts arbitrarily sampled and visually observing the residual of the toner on the intermediate transfer belts in the width of the cleaning blade. Table 1 shows the result of the belt worst in evaluation. Retention of the toner results in cleaning defect.

The evaluation criteria for the cleaning defect shown in Table 1 are as follows:

“G1”: No cleaning defect

“G3”: Cleaning defect observed

These measurement results and evaluation results are summarized in the following Table 1.

The particle size distributions (50 percentile particle diameter, 90 percentile particle diameter, and 100 percentile particle diameter) of the pulverized polyanilines used in preparation of the intermediate transfer belts in Examples 1 and 2 and Comparative Examples 1 to 3 and the casting methods of the polyimide resin are also shown in Table 1.

Among measurement results, the result worst in evaluation is used as the overall rating for each of the samples in Examples and Comparative Examples.

TABLE 1

| | | | | | | Comparative | | Comparative | | Comparative | |
|---|---|---|---|---|---|---|---|---|---|---|---|
| | | Example 1 | | Example 2 | | Example 1 | | Example 2 | | Example 3 | |
| | | Dispersion: B-1 | | Dispersion: B-2 | | Dispersion: B-3 | | Dispersion: b-1 | | Solution: b-2 | |
| Composition | 50%, 90%, and 100 | 1.4, 2.4, 5.9 | | 2.7, 4.3, 7.7 | | 15.5, 25.3, 48.5 | | 3.2, 7.4, 30.2 | | Solution | |
| of coating | percentile particle diameters | | | | | | | | | (gel included) | |
| solution | Solid-content mass ratio | 12:88 | | 12:88 | | 12:88 | | 10:90 | | 12:88 | |
| | (PAn:PAA) | | | | | | | | | | |
| Method | Casting method | (B) Circular | | (B) Circular | | (B) Circular | | (B) Circular | | (B) Circular | |
| | | cylinder metal | | cylinder metal | | cylinder metal | | cylinder metal | | cylinder metal | |
| | | mold, coating | | mold, coating | | mold, coating | | mold, coating | | mold, coating | |
| Polyaniline | Absolute maximum length | 6.6 | | 8.3 | | 47.1 | | 33.1 | | 12.4 | |
| particles in | of the largest polyaniline | | | | | | | | | | |
| belt | particle (μm) | | | | | | | | | | |
| | 50 and 90 percentile | 1.5, 2.5 | | 3.0, 4.7 | | 10.2, 16.4 | | 3.5, 8.1 | | Not measured | |
| | particle diameters | | | | | | | | | | |
| | (μm) | | | | | | | | | | |
| | 90 percentile particle | 1.67 | | 1.57 | | 1.61 | | 2.31 | | Not measured | |
| | diameters/ | | | | | | | | | | |
| | 50 percentile particle | | | | | | | | | | |
| | diameters | | | | | | | | | | |
| Yield | Number of belts satisfying | G1 | 19 | G2 | 18 | G3 | 13 | G3 | 15 | G3 | 14 |
| | requirement (Out of 20) | | | | | | | | | | |
| Electrical | Surface resistivity | G1 | 12.2 ± 0.1 | G1 | 12.2 ± 0.1 | G2 | 12.2 ± 0.2 | G2 | 12.1 ± 0.2 | G1 | 12.1 ± 0.1 |
| properties | (logΩ/cm²) | | | | | | | | | | |
| | Volumetric resistivity | G1 | 11.8 ± 0.1 | G2 | 11.8 ± 0.2 | G3 | 11.9 ± 0.3 | G2 | 11.7 ± 0.2 | G1 | 11.4 ± 0.1 |
| | (logΩcm) | | | | | | | | | | |
| Surface | Surface roughness Ra (μm) | G1 | 0.025 to 0.035 | G2 | 0.056 to 0.064 | G3 | 0.082 to 0.88 | G3 | 0.081 to 0.086 | G1 | 0.025 to 0.035 |
| physical | Micro-glossiness at 75° | G1 | 107 to 112 | G1 | 98 to 104 | G3 | 85 to 91 | G3 | 87 to 93 | G1 | 102 to 109 |
| properties | angle (gloss unit) | | | | | | | | | | |
| | Sharpness | G1 | Minimum | G2 | Minimum | G3 | Minimum | G3 | Minimum | G1 | Minimum |
| | (reflection of lattice pattern) | | lattice | | lattice | | lattice | | lattice | | lattice |
| | | | distortion, | | distortion, | | distortion, | | distortion, | | distortion, |
| | | | definite | | blurred | | thick | | thick | | definite |
| | | | and thin | | thicker | | blurred | | blurred | | and thin |
| | | | lattice line | | lattice line | | lattice line | | lattice line | | lattice line |
| Evaluation | Half-tone graininess | G1 | Favorable | G2 | Somewhat | G3 | Very | G3 | Very | G1 | Favorable |
| of | | | (smooth) | | dissatisfied | | dissatisfied | | dissatisfied | | (smooth) |
| transferred | White deletion | G1 | None | G1 | None | G3 | Generated | G3 | Generated | G3 | Generated |
| image | (M30% H/T) | | | | | | (blurred) | | (blurred) | | (white spots) |
| | Cleaning defect | G1 | None | G1 | None | G3 | Generated | G3 | Generated | G1 | None |

| | | | | | |
|---|---|---|---|---|---|
| Overall rating | G1 | G2 | G3 | G3 | G3 |

### Example 3

<Preparation of Self-Doping Polyaniline>

A conductive coating agent aquaPASS-01 (aqueous solution of polyaniline sulfonic acid) manufactured by Mitsubishi Rayon Co., Ltd. is dried and pulverized, for example, in an evaporator, to give a powdery polyaniline sulfonic acid (PAS; average molecular weight: 10,000, average diameter: approximately 9 μm) as self-doping polyaniline.

<Preparation of Polyaniline Sulfonic Acid Dispersion (B-4)>

The self-doping polyaniline, powdery polyaniline sulfonic acid, is pulverized in a dry jet mill. The dry jet mill used is a counter jet mill (type 100AFG) manufactured by Hosokawamicron Corporation.

The counter jet mill contains (1) a raw material-supplying unit FTS-20, (2) a counter jet mill 100AFG, (3) a product-collecting unit-1 (Φ100 cyclone), (4) a product-collecting unit-2 (P-bag: filtration area: 2.3 square meter), and (5) an exhaust blower. The main conditions for pulverization are as follows: pulverization air flow: 100 cubic meters per minute, air pressure: 600 kPa, and classification rotational velocity: 20,000 rpm.

The polyaniline collected in the product-collecting unit-2 (P-bag) is designated as the third polyaniline particles, and a small amount thereof is dispersed in ethanol. Analysis of the particle size distribution of the third polyaniline particle shows: that the 50 percentile particle diameter (volume basis) is 1.8 μm; the 90 percentile particle diameter (volume basis), 3.3 μm; and the 100 percentile particle diameter (volume basis), 7.8 μm.

15 parts by mass of PVP (polyvinylpyrrolidone) is added to 1,700 parts by mass of DMAc under nitrogen atmosphere; the mixture is stirred uniformly at room temperature (22° C.); and 250 parts by mass of the powdery polyaniline sulfonic acid (PAS: the third polyaniline particle) is added gradually to the solution, to give a polyaniline sulfonic acid dispersion (B-4), a liquid mixture containing polyaniline sulfonic acid at 13 mass %.

<Preparation of Coating Solution (C-2)>

The polyamic acid solution (A-1) and the polyaniline sulfonic acid dispersion (B-4) obtained by the method above are mixed uniformly, to give a coating solution. The solid-content mass ratio of the polyaniline sulfonic acid (PAS) to the polyamic acid (PAA), PAS:PAA, is 10:90. DMAc solvent is added as needed to adjust its viscosity in the range suitable for coating.

<Preparation of Endless Belt>

The coating solution obtained is coated uniformly on the inner surface of a cylindrical SUS mold having an inner diameter of 365.5 mm and a length of 600 mm. The inner surface of the cylindrical mold is previously coated with a fluorine-based releasing agent for facilitating removal of the belt after preparation.

Then, the coated film is dried at a temperature of 120° C. for 30 minutes while the metal mold is rotated. After drying, the metal mold is baked in an oven at 320° C. approximately for 30 minutes, allowing the imide conversion reaction to proceed.

The metal mold is then cooled to room temperature, and the resin is removed from the metal mold, to give an endless belt.

Both ends of the endless belt obtained are cut off, to give an intermediate transfer belt having a peripheral length of 1,148 mm and a width of 369 mm. The thickness of the intermediate transfer belt is 0.08 mm.

### Example 4

An intermediate transfer belt of Example 4 is prepared in a similar manner to Example 3, except that the polyaniline sulfonic acid dispersion (B-4) used in Example 3 is replaced with the following polyaniline sulfonic acid dispersion (B-5).

<Preparation of Polyaniline Sulfonic Acid Dispersion (B-5)>

A small portion of the polyaniline sulfonic acid collected in the product-collecting unit-1 (Φ10 cyclone) in the polyaniline sulfonic acid pulverized during preparation of the polyaniline sulfonic acid dispersion (B-4), which will be referred to as the fourth polyaniline particle, is dispersed in ethanol. Analysis of the particle size distribution of the fourth polyaniline particle shows: that the 50 percentile particle diameter (volume basis) is 3.0 μm; the 90 percentile particle diameter (volume basis), 4.4 μm; and the 100 percentile particle diameter (volume basis), 9.3 μm.

15 parts by mass of PVP (polyvinylpyrrolidone) is added to 1,700 parts by mass of DMAc under nitrogen atmosphere; the mixture is stirred uniformly at room temperature (22° C.); and 250 parts by mass of the fourth polyaniline particles are added gradually to the solution, to give a mixed liquid containing polyaniline sulfonic acid at 13 mass %, which will be referred to as a polyaniline sulfonic acid dispersion (B-5).

### Comparative Example 4

An intermediate transfer belt of Comparative Example 4 is prepared in a similar manner to Example 3, except that the polyaniline sulfonic acid dispersion (B-4) used in Example 3 is replaced with the following polyaniline sulfonic acid dispersion (B-6).

<Preparation of Polyaniline Sulfonic Acid Dispersion (B-6)>

15 parts by mass of PVP (polyvinylpyrrolidone) is added to 1,700 parts by mass of DMAc under nitrogen atmosphere, and 250 parts by mass of powdery polyaniline sulfonic acid (PAS) is added gradually to the solution, to give a liquid mixture containing polyaniline sulfonic acid at 13 mass %, which will be referred to as polyaniline sulfonic acid dispersion (B-6).

Analysis of the particle size distribution of the polyaniline sulfonic acid in the polyaniline sulfonic acid dispersion (B-6) shows that the 50 percentile particle diameter (volume basis) is 7.9 μm; the 90 percentile particle diameter (volume basis), 12.2 μm; and the 100 percentile particle diameter (volume basis), 29.9 μm.

[Evaluation]

The “absolute maximum length of the largest polyaniline particle” and the “particle size distribution (number basis) of polyaniline particle” of the particles in each of the intermediate transfer belts obtained in Examples 3 and 4 and Comparative Example 4 are determined according to a method similar to that in Example 1, and the “yield”, “electrical properties”, “surface physical properties”, and “quality of transferred image” of the intermediate transfer belt are also evaluated. Measurement and evaluation results are summarized in the following shown in Table 2.

In addition, the particle size distribution (50 percentile particle diameter, 90 percentile particle diameter, 100 percentile particle diameter) of the pulverized polyanilines used in preparation of each of the intermediate transfer belts in Examples 3 and 4 and Comparative Example 4 and the casting method of the polyimide resin are also shown in Table 2.

TABLE 2

| | | Example 3 | | Example 4 | | Comparative Example 4 | |
|---|---|---|---|---|---|---|---|
| | | Dispersion: B-4 | | Dispersion: B-5 | | Dispersion: B-6 | |
| Composition of | 50, 90, and 100 percentile particle | 1.8, 3.3, 7.8 | | 3.0, 4.4, 9.3 | | 7.9, 12.2, 29.9 | |
| coating solution | diameters (μm) | | | | | | |
| | Solid-content mass ratio (PAS:PAA) | 10:90 | | 10:90 | | 10:90 | |
| Method | Casting method | (B) Circular cylinder metal | | (B) Circular cylinder | | (B) Circular cylinder metal | |
| | | mold, coating | | metal mold, coating | | mold, coating | |
| Polyaniline particles | Absolute maximum length of the largest | 8.1 | | 9.7 | | 32.1 | |
| in belt | polyaniline particle (μm) | | | | | | |
| | 50 and 90 percentile particle diameters | 2.0, 3.6 | | 3.2, 4.9 | | 8.2, 12.9 | |
| | (μm) | | | | | | |
| | 90 percentile particle diameters/ | 1.8 | | 1.53 | | 1.57 | |
| | 50 percentile particle diameters | | | | | | |
| Yield | Number of belts satisfying requirement | G1 | 19 | G2 | 17 | G3 | 15 |
| | (Out of 20) | | | | | | |
| Electrical properties | Surface resistivity (logΩ/cm²) | G1 | 12.2 ± 0.1 | G1 | 12.2 ± 0.1 | G2 | 12.1 ± 0.2 |
| | Volumetric resistivity (logΩcm) | G1 | 11.8 ± 0.1 | G2 | 11.8 ± 0.2 | G2 | 11.7 ± 0.2 |
| Surface physical | Surface roughness Ra (μm) | G1 | 0.027 to 0.038 | G2 | 0.058 to 0.066 | G3 | 0.078 to 0.85 |
| properties | Micro-glossiness at 75° angle | G1 | 101 to 106 | G1 | 96 to 102 | G3 | 88 to 94 |
| | (gloss unit) | | | | | | |
| | Sharpness | G1 | Minimum lattice | G2 | Minimum lattice | G3 | Minimum lattice |
| | (reflection of lattice pattern) | | distortion, definite and | | distortion, blurred | | distortion, thick |
| | | | thin lattice line | | thicker lattice line | | blurred lattice line |
| Evaluation of | Half-tone graininess | G1 | Favorable (smooth) | G2 | Somewhat | G3 | Very dissatisfied |
| transferred image | | | | | dissatisfied | | |
| | White deletion (M30% H/T) | G1 | None | G1 | None | G3 | Generated (blurred) |
| | Cleaning defect | G1 | None | G1 | None | G3 | Generated |

| | | | |
|---|---|---|---|
| Overall rating | G1 | G2 | G3 |

### Example 5

<Preparation of Polyamic Acid Solution (A-2)>

3,3′,4,4′-biphenyltetracarboxylic dianhydride (BPDA) is added to a DMAc solution of 4,4′-diaminodiphenylether (ODA), and the mixture is stirred sufficiently under nitrogen atmosphere. The molar ratio of ODA: BPDA is 1.00:1.00, and thus, a polyamic acid solution (A-2) at a concentration of 20 mass % is obtained.

<Preparation of Coating Solution (C-3)>

The polyamic acid solution (A-2) and a filler (tin oxide), and additionally DMAc solvent, are added to the doped polyaniline dispersion (B-1) obtained by the method above, and the mixture is stirred sufficiently and deaerated, to give a coating solution (C-3). The viscosity of the coating solution (C) is adjusted to 20 to 40 Pa·s.

The solid-content mass ratio of doped polyaniline (PAn), polyamic acid (PAA), and filler (tin oxide) in the coating solution (C-3), PAn:PAA:tin oxide, is 10.8:79.2:10.0.

The tin oxide used as the filler is a metal oxide, antimony-doped tin oxide (hereinafter, referred to simply as “tin oxide”) having a specific gravity of 7.0 g/ml.

<Preparation of Endless Belt>

The coating solution obtained is coated uniformly on the outer surface of a cylindrical SUS mold having an outer diameter of 365.5 mm and a length of 600 mm, and the thickness of the coating solution on the cylindrical metal mold is controlled uniformly, by scraping off excessive coating solution with a film thickness-controlling mold connected to the cylindrical metal mold moving in the direction parallel to the mold.

Then, the coated film is dried at a temperature of 120° C. for 30 minutes while the metal mold is rotated. After drying, the metal mold is baked in an oven at 320° C. for 30 minutes, allowing the imide-conversion reaction to proceed.

The metal mold is then cooled to room temperature, and the resin is removed from the metal mold, to give an endless belt.

Two endless belts thus prepared are cut into two in the metal-mold length direction, and the two belts are connected to each other, forming a sheet. The belts are connected, for example, according to the puzzle-cut seaming method described in JP-A No. 2000-145895. The sheet is cut into a piece having a width of 362 mm, and both ends are puzzle-cut seamed, to give an endless belt having a width of 362 mm and a peripheral length of 2,111 mm. The thickness of the intermediate transfer belt is 0.08 mm.

### Example 6

An intermediate transfer belt of Example 6 is prepared in a similar manner to Example 5, except that the filler tin oxide used in Example 5 is replaced with titanium oxide and the solid-content mass ratio of doped polyaniline (PAn), polyamic acid (PAA), and filler (titanium oxide), PAn:PAA:titanium oxide, in the coating solution (C-3) is changed to 10.1:79.9:10.0.

The titanium oxide used as the filler is a metal oxide, antimony-doped titanium oxide (hereinafter, referred to as “titanium oxide”) having a specific gravity 5.0 g/ml.

### Example 7

An intermediate transfer belt of Example 7 is prepared in a similar manner to Example 5, except that the polyamic acid solution (A-2) used in Example 3 is replaced with the following polyamic acid solution (A-3).

<Preparation of Polyamic Acid Solution (A-3)>

3,3′,4,4′-biphenyltetracarboxylic dianhydride (BPDA) and pyromellitic dianhydride (PMDA) are added to a DMAc solution of 4,4′-diaminodiphenylether (ODA), and the mixture is stirred sufficiently under nitrogen atmosphere. The ratio of ODA: BPDA: PMDA is 1.00:0.80:0.20, and thus, a polyamic acid solution (A-3) at a concentration of 20 mass % is obtained.

### Example 8

An intermediate transfer belt of Example 8 is prepared in a similar manner to Example 5, except that the polyamic acid solution (A-2) used in Example 5 is replaced with the polyamic acid solution (A-3) and the solid-content mass ratio of doped polyaniline (PAn), polyamic acid (PAA), and filler (tin oxide), PAn:PAA:tin oxide, in the coating solution is changed to 10.8:74.2:15.0.

### Example 9

An intermediate transfer belt of Example 9 is prepared in a similar manner to Example 5, except that the polyamic acid solution (A-2) used in Example 5 is replaced with the polyamic acid solution (A-4) and the solid-content mass ratio of doped polyaniline (PAn), polyamic acid (PAA), and filler (tin oxide), PAn:PAA:tin oxide, is changed to 10.1:74.9:15.0.

<Preparation of Polyamic Acid Solution (A-4)>

3,3′,4,4′-biphenyltetracarboxylic dianhydride (BPDA) and pyromellitic dianhydride (PMDA) are added to a DMAc solution of 4,4′-diaminodiphenylether (ODA), and the mixture is stirred sufficiently under nitrogen atmosphere. The molar ratio of ODA:BPDA:PMDA is 1.00:0.55:0.45, and thus, a polyamic acid solution (A-4) at a concentration of 20 mass % is obtained.

### Example 10

An intermediate transfer belt of Example 10 is prepared in a similar manner to Example 5, except that the polyamic acid solution (A-2) used in Example 5 is replaced with the polyamic acid solution (A-4), titanium oxide is used as the filler, and the solid-content mass ratio of doped polyaniline (PAn), polyamic acid (PAA), and filler (titanium oxide) PAn:PAA:titanium oxide in the coating solution (C-3) is changed to 10.1:74.9:15.0.

[Evaluation]

The “absolute maximum length of the largest polyaniline particle”, and “particle size distribution (number basis) of polyaniline particle” of the particles in each of the intermediate transfer belts obtained in Examples 5 to 10 are determined according to methods similar to those in Example 1, and in addition, the “absolute maximum length of filler maximum particle” is determined by the following method:

The “absolute maximum length of filler maximum particle” is determined by sampling nine points, respectively three points in the width direction×three points in the length direction on a belt, in a similar manner to the measurement of polyaniline particles, and evaluated according to the method described above. Results are summarized in Table 3.

The kind of polyamic acids, the solid-content mass ratio of polyaniline, polyamic acid, and filler, and the kind and content (vol %) of fillers contained in the coating solutions used in preparation of the intermediate transfer belts in Examples 5 to 10 are also summarized in Table 3.

In addition, the “yield”, “electrical properties”, “surface physical properties”, and “quality of transferred image” of the intermediate transfer belts obtained in Examples 5 to 10 are also evaluated according to the methods similar to those in Example 1, and in addition, the “surface physical property” (microhardness), “expansion”, “tensile strength”, and “walk distance during image formation” of them are also evaluated according to the following methods: Evaluation results are summarized in the following Table 4.

“Evaluation of Surface Physical Property”

(Measurement of Micro-Hardness)

The micro-hardness is determined by preparing samples of arbitrary three points on each of three intermediate transfer belts arbitrarily sampled according to the method above and measuring ten points on each sample, and the average of three samples are designated as the micro-hardness of the belt. Table 4 shows the result of the belt worst in evaluation.

The evaluation criteria for the micro-hardness shown in Table 4 are as follows:

“G0”: 20 or less (favorable)

“G1”: More than 20 and 25 or less (satisfactory)

“G2”: More than 25 and 30 or less (demanding adjustment of the system)

“G3”: 30 or more (practically unusable) (unsatisfactory)

“Evaluation of Belt Expansion”

(Measurement of Humidity Expansion Coefficient)

The humidity expansion coefficient is determined by preparing a sample of arbitrary one point on each of three intermediate transfer belts arbitrarily sampled and measuring the sample according to the method described above. Table 4 shows the result of the belt worst in evaluation.

The evaluation criteria for the humidity expansion coefficient shown in Table 4 are as follows:

“G0”: 30 ppm/% RH or less (favorable)

“G1”: More than 30 ppm/% RH and 45 ppm/% RH or less (satisfactory)

“G2”: More than 45 ppm/% RH and 60 ppm/% RH or less (demanding adjustment of the system)

“G3”: 60 ppm/% RH or more (unsatisfactory)

(Measurement of Thermal Expansion Coefficient)

The thermal expansion coefficient is determined by preparing a sample of arbitrary one point on each of three intermediate transfer belts arbitrarily sampled and measuring the sample according to the method described above. Table 4 shows the result of the belt worst in evaluation.

The evaluation criteria for the thermal expansion coefficient shown in Table 4 are as follows:

“G0”: 30 ppm/K or less (favorable)

“G1”: More than 30 ppm/K and 45 ppm/K or less (satisfactory)

“G2”: More than 45 ppm/K and 60 ppm/K or less (demanding adjustment of the system)

“G3”: 60 ppm/K or more (unsatisfactory)

“Evaluation of Belt Tensile Strength”

(Measurement of Tensile Elastic Modulus)

The tensile elastic modulus is determined by preparing samples of arbitrary ten points on each of three intermediate transfer belts arbitrarily sampled and measuring the sample according to the method described above. The intermediate transfer belt measured is preconditioned in an environment of 28° C. and 85% RH (A zone) or in an environment of 22° C. and 55% RH environment (B zone) for 24 hours. Table 4 summarizes the averages.

The evaluation criteria for the humidity expansion coefficient shown in Table 4 are as follows:

“G0”: 3,500 MPa or more (favorable)

“G1”: Less than 3,500 MPa and 2,500 MPa or more (satisfactory)

“G2”: Less than 2,500 MPa and 2,300 MPa or more (demanding adjustment of the system)

“G3”: Less than 2,300 MPa (unsatisfactory)

“Evaluation of the Walk Distance During Image Formation”

The walk distance during image formation is evaluated by placing each of three intermediate transfer belts arbitrarily sampled in Color DocuTech 60 manufactured by Fuji Xerox Co., Ltd., a device similar to the image-forming device shown in FIG. 1.

The walk distance according to the invention means a distance of a belt still moving even when the drive of the intermediate transfer belt is controlled by the drive-controlling method described in Japanese Patent No. 3632731 (active steering method).

A typical method of determining the walk distance is described below:

First, the Color DocuTech 60 is placed in an environment of 22° C. and 55% RH. Separately, an intermediate transfer belt is left and conditioned in an environment of 22° C. and 55% RH for 24 hours or more. Then, the conditioned intermediate transfer belt is placed in the Color DocuTech 60, and the apparatus is turned on.

The edge shape data of the installed intermediate transfer belt are obtained and stored in a memory part.

Then, an image is printed on 20 sheets of A3 paper. The intermediate transfer belt rotates five times at the time. The edge shape data of the intermediate transfer belt during each printing are also collected. Edge shape data obtained during each printing evaluated whether is acceptable by comparison with the edge shape data stored in the memory part, and if not acceptable, the edge shape data stored in the memory part is revised with the edge shape data newly observed.

The walk distance is calculated from the edge shape data at each measurement point stored in the memory part and the edge shape data measured at each measurement point.

Separately, the intermediate transfer belt is placed in the Color DocuTech 60, and the apparatus is turned on and left as it is for 60 minutes.

An image is then printed on 20 sheets of A3 paper, and the walk distance is determined similarly as described above.

Deformation of the edge shape, if it occurs during storage for 60 minutes, leads to elongation of the walk distance.

A walk distance of 22.4 μm or less at each edge shape-measuring point is ranked G1 (acceptable), and that of more than 22.4 μm is ranked G3 (practically unusable).

The methods of measuring the edge shape and of controlling, for example, comparing and revising, the edge shape values are those described in Japanese Patent No. 3632731, the disclosure of which is incorporated by reference herein.

Separately, after the Color DocuTech 60 and the intermediate transfer belt are preconditioned under an environment of 28° C. and 85% RH, the walk distance is also determined similarly. The results are also summarized in Table 4.

The walk distance in zone A in Table 4, is a walk distance when the Color DocuTech 60 is placed and the intermediate transfer belt is left and conditioned in an environment of 28° C. and 85% RH. Similarly, the walk distance in zone B is a walk distance when the Color DocuTech 60 is placed and the intermediate transfer belt is left and conditioned in an environment of 22° C. and 55% RH.

TABLE 3

| | | Example 5 | Example 6 | Example 7 |
|---|---|---|---|---|
| Composition | Kind of polyamic acid | ODA:BPDA = 1.0:1.0 | ODA:BPDA = 1.0:1.0 | ODA:BPDA:PMDA = |
| of coating | | | | 1.0:0.8:0.2 |
| solution | Solid-content mass ratio | 10.8:79.2:10.0 | 10.1:79.9:10.0 | 10.8:79.2:10.0 |
| | (PAn:PAA:filler) | | | |
| | Kind of filler | Tin oxide | Titanium oxide | Tin oxide |
| | Content of filler (vol %) | 2.3 | 3.2 | 2.3 |
| Intermediate | Absolute maximum length of | 6.6 | 6.6 | 6.6 |
| transfer belt | the largest polyaniline particle | | | |
| | (μm) | | | |
| | 50 and 90 percentile particle | 1.5, 2.5 | 1.5, 2.5 | 1.5, 2.5 |
| | diameters (μm) | | | |
| | 90 percentile particle diameter/ | 1.67 | 1.67 | 1.67 |
| | 50 percentile particle diameter | | | |
| | Absolute maximum length of | 2.4 | 2.0 | 2.4 |
| | filler maximum particle (μm) | | | |
| | | Example 8 | Example 9 | Example 10 |
| Composition | Kind of polyamic acid | ODA:BPDA:PMDA = | ODA:BPDA:PMDA = | ODA:BPDA:PMDA = |
| of coating | | 1.0:0.8:0.2 | 1.0:0.55:0.45 | 1.0:0.55:0.45 |
| solution | Solid-content mass ratio | 10.1:74.9:15.0 | 10.1:74.9:15.0 | 10.1:74.9:15.0 |
| | (PAn:PAA:filler) | | | |
| | Kind of filler | Tin oxide | Tin oxide | Titanium oxide |
| | Content of filler (vol %) | 3.2 | 3.2 | 3.2 |
| Intermediate | Absolute maximum length of | 6.6 | 6.6 | 6.6 |
| transfer belt | the largest polyaniline particle | | | |
| | (μm) | | | |
| | 50 and 90 percentile particle | 1.5, 2.5 | 1.5, 2.5 | 1.5, 2.5 |
| | diameters (μm) | | | |
| | 90 percentile particle diameter/ | 1.67 | 1.67 | 1.67 |
| | 50 percentile particle diameter | | | |
| | Absolute maximum length of | 2.4 | 2.4 | 2.0 |
| | filler maximum particle (μm) | | | |

TABLE 4

| | | Example 5 | | Example 6 | | Example 7 | |
|---|---|---|---|---|---|---|---|
| Yield | Number of belts satisfactory in | G1 | 19 | G1 | 19 | G1 | 19 |
| | appearance (out of 20) | | | | | | |
| Electrical | Surface resistivity (logΩ/cm²) | G1 | 12.0 ± 0.1 | G1 | 12.2 ± 0.1 | G1 | 12.0 ± 0.1 |
| properties | Volumetric resistivity (logΩcm) | G1 | 11.6 ± 0.1 | G1 | 11.8 ± 0.1 | G1 | 11.6 ± 0.1 |
| Surface | Surface roughness Ra (μm) | G1 | 0.035 to 0.044 | G1 | 0.039 to 0.047 | G1 | 0.034 to 0.043 |
| physical | Micro-glossiness at 75° | G1 | 105 to 110 | G1 | 103 to 107 | G1 | 108 to 114 |
| properties | (gloss unit) | | | | | | |
| | Micro-hardness (mN/μm) | G1 | 22 | G1 | 22 | G1 | 21 |
| | Sharpness | G1 | Minimum | G1 | Minimum | G1 | Minimum |
| | (reflection of lattice pattern) | | lattice | | lattice | | lattice |
| | | | distortion, | | distortion, | | distortion, |
| | | | definite thin | | definite thin | | definite thin |
| | | | lattice line | | lattice line | | lattice line |
| Expansion | Humidity expansion coefficient | G1 | 31 | G1 | 34 | G1 | 36 |
| | (ppm/% RH) | | | | | | |
| | Thermal expansion coefficient | G1 | 31 | G1 | 33 | G1 | 37 |
| | (ppm/K) | | | | | | |
| Tensile strength | Tensile elastic modulus in zone A | G1 | 3090 | G1 | 2990 | G1 | 2970 |
| | (Mpa) | | | | | | |
| | Tensile elastic modulus in zone B | G1 | 3110 | G1 | 3050 | G1 | 2980 |
| | (Mpa) | | | | | | |

| | | | | | |
|---|---|---|---|---|---|
| Walk distance | Zone A | Power supply turned | G1 | G1 | G1 |
| during image | | on → printing | | | |
| formation | | Left for 60 minutes → | G1 | G1 | G1 |
| | | printing | | | |
| | Zone B | Power supply turned | G1 | G1 | G1 |
| | | on → printing | | | |
| | | Left for 60 minutes → | G1 | G1 | G1 |
| | | printing | | | |

| Evaluation of | Half-tone graininess | G1 | | G1 | | G1 | |
|---|---|---|---|---|---|---|---|
| transferred | White deletion (M30% H/T) | G1 | | G1 | | G1 | |
| image | Cleaning defect | G1 | | G1 | | G1 | |
| Overall rating | | G1 | | G1 | | G1 | |
| | | Example 8 | | Example 9 | | Example 10 | |
| Yield | Number of belts satisfactory in | G1 | 19 | G1 | 19 | G1 | 19 |
| | appearance (out of 20) | | | | | | |
| Electrical | Surface resistivity (logΩ/cm²) | G1 | 12.0 ± 0.1 | G1 | 12.0 ± 0.1 | G1 | 12.2 ± 0.1 |
| properties | Volumetric resistivity (logΩcm) | G1 | 11.6 ± 0.1 | G1 | 11.6 ± 0.1 | G1 | 11.8 ± 0.1 |
| Surface | Surface roughness Ra (μm) | G1 | 0.041 to 0.048 | G1 | 0.040 to 0.048 | G1 | 0.033 to 0.042 |
| physical | Micro-glossiness at 75° | G1 | 101 to 105 | G1 | 113 to 117 | G1 | 107 to 111 |
| properties | (gloss unit) | | | | | | |
| | Micro-hardness (mN/μm) | G1 | 22 | G1 | 21 | G1 | 21 |
| | Sharpness | G1 | Minimum | G1 | Minimum | G1 | Minimum |
| | (reflection of lattice pattern) | | lattice | | lattice | | lattice |
| | | | distortion, | | distortion, | | distortion, |
| | | | definite thin | | definite thin | | definite thin |
| | | | lattice line | | lattice line | | lattice line |
| Expansion | Humidity expansion coefficient | G1 | 33 | G1 | 37 | G1 | 38 |
| | (ppm/% RH) | | | | | | |
| | Thermal expansion coefficient | G1 | 33 | G1 | 38 | G1 | 38 |
| | (ppm/K) | | | | | | |
| Tensile strength | Tensile elastic modulus in zone A | G1 | 3130 | G1 | 2970 | G1 | 2980 |
| | (Mpa) | | | | | | |
| | Tensile elastic modulus in zone B | G1 | 3200 | G1 | 3010 | G1 | 3010 |
| | (Mpa) | | | | | | |

| | | | | | |
|---|---|---|---|---|---|
| Walk distance | Zone A | Power supply turned | G1 | G1 | G1 |
| during image | | on → printing | | | |
| formation | | Left for 60 minutes → | G1 | G1 | G1 |
| | | printing | | | |
| | Zone B | Power supply turned | G1 | G1 | G1 |
| | | on → printing | | | |
| | | Left for 60 minutes → | G1 | G1 | G1 |
| | | printing | | | |

| | | | | |
|---|---|---|---|---|
| Evaluation of | Half-tone graininess | G1 | G1 | G1 |
| transferred | White deletion (M30% H/T) | G1 | G1 | G1 |
| image | Cleaning defect | G1 | G1 | G1 |

| | | | |
|---|---|---|---|
| Overall rating | G1 | G1 | G1 |

As apparent from Tables 1, 2, and 4, the intermediate transfer belts according to the invention (intermediate transfer belt prepared by the method of preparing the intermediate transfer belt according to the invention) are superior all in the number satisfying requirement, electrical properties, and surface physical properties; and the image-forming devices equipped with the intermediate transfer belt have a smaller walk distance during image formation and give high-quality transferred images.

In addition, the intermediate transfer belts additionally containing a filler are superior in expansion resistance and tensile strength; and the image-forming devices equipped with the intermediate transfer belt have a smaller walk distance during image formation and give high-quality transferred images.

In contrast, the intermediate transfer belts obtained in Comparative Examples 1 to 4, which contain particles having an absolute maximum length of the largest polyaniline particle at more than 10.0 μm, have practical problems in surface physical properties, although they do not have problems in electrical characteristic, and causes deterioration in the quality of transferred image seemingly due to fluctuation in resistivity in microregions when these intermediate transfer belts are used in an image-forming device.

According to an aspect of the invention, an intermediate transfer belt, containing no gel particles larger in particle diameter, is superior in surface smoothness and smaller in the fluctuation of resistivity in micro regions.

It also provides an image-forming device using the intermediate transfer belt that gives high-quality transferred images.

All publications, patent applications, and technical standards mentioned in this specification are herein incorporated by reference to the same extent as if each individual publication, patent application, or technical standard was specifically and individually indicated to be incorporated by reference.

What is claimed is:

1. An intermediate transfer belt comprising a polyimide resin comprising a polyaniline, wherein the absolute maximum length of the largest particle of the polyaniline is approximately 10.0 μm or less.

2. The intermediate transfer belt of claim 1, wherein the particles of polyaniline have:
a 50 percentile particle diameter (number basis) in the range of approximately 0.05 to 3.0 μm; and a 90 percentile particle diameter (number basis) of one to two times the 50 percentile particle diameter (number basis).

3. The intermediate transfer belt of claim 1, wherein the polyimide resin further comprises a filler and the absolute maximum length of the largest particle of the polyaniline (a) and the absolute maximum length of the largest filler particle (b) satisfy the relationship represented by the following Formula (1):
10.0 μm≧Absolute maximum length (a)>Absolute maximum length (b)≧0.1 μm (1)

4. The intermediate transfer belt of claim 3, wherein the filler is a filler selected from silica, alumina, mica, talc, barium sulfate, tin oxide, antimony-doped tin oxide, indium-doped tin oxide, antimony-doped titanium oxide, and carbon black.

5. The intermediate transfer belt of claim 1, wherein the polyimide resin comprises a copolymer of 3,3′,4,4′-biphenyltetracarboxylic dianhydride and 4,4′-diaminodiphenylether.

6. The intermediate transfer belt of claim 1, wherein the polyimide resin comprises a copolymer of 3,3′,4,4′-biphenyltetracarboxylic dianhydride and 4,4′-diaminodiphenylether and a copolymer of pyromellitic dianhydride and 4,4′-diaminodiphenylether.

7. The intermediate transfer belt of claim 1, wherein the polyimide resin further comprises a dopant for making the polyaniline conductive.

8. The intermediate transfer belt of claim 7, wherein the dopant is a protonic acid having an acid dissociation constant pKa of approximately 4.8 or less.

9. The intermediate transfer belt of claim 1, wherein the polyaniline is a self-doping polyaniline.

10. The intermediate transfer belt of claim 1, wherein a surface roughness Ra thereof is in the range of approximately 0.010 to 0.050 μm.

11. The intermediate transfer belt of claim 1, wherein a micro-glossiness of the transfer face thereof at an incident angle of 75° is in the range of approximately 95 to 120 gloss units.

12. The intermediate transfer belt of claim 1, wherein a humidity expansion coefficient thereof is approximately 45 ppm/% RH or less and a thermal expansion coefficient thereof is approximately 45 ppm/K or less.

13. The intermediate transfer belt of claim 1, wherein a surface micro-hardness thereof is approximately 25 mN/μm² or less.

14. The intermediate transfer belt of claim 1, wherein a tensile elastic modulus thereof is approximately 2,500 MPa or more.

15. The intermediate transfer belt of claim 1, wherein a surface resistivity thereof is in the range of approximately 1×10¹⁰ to 1×10¹⁴ Ω/cm².

16. The intermediate transfer belt of claim 1, wherein a volumetric resistivity thereof is in the range of approximately 1×10⁸ to 1×10¹⁴ Ωcm.

17. An image-forming device comprising an image holding member whereon an electrostatic latent image corresponding to image information is formed, a developing device making visible the electrostatic latent image formed on the image holding member as a toner image with a toner, an intermediate transfer belt whereon the toner image formed on the image holding member is primary-transferred, and a bias mechanism which secondary-transfers the unfixed toner image on the intermediate transfer belt onto a recording medium, wherein
the intermediate transfer belt is the intermediate transfer belt of claim 1.

18. A method of producing an intermediate transfer belt comprising:
pulverizing a polyaniline in an undoped state into particles having a 50 percentile particle diameter (volume basis) in the range of approximately 0.05 to 3.0 μm and a 90 percentile particle diameter (volume basis) in the range of one to two times the 50 percentile particle diameter (volume basis);
adding a dopant for making the polyaniline conductive thereto;
blending the mixture with a polyamic acid; and
drying and sintering the mixture.

19. A method of producing an intermediate transfer belt comprising:
pulverizing a self-doping polyaniline into particles having a 50 percentile particle diameter (volume basis) in the range of approximately 0.05 to 3.0 μm and a 90 percentile particle diameter (volume basis) in the range of one to two times the 50 percentile particle diameter (volume basis);
mixing the particles with a polyamic acid; and
drying and sintering the mixture.
